(19) United States
(12) Patent Application Publication
(10) Pub. No.: US 2026/0095330 A1
(43) Pub. Date: Apr. 2, 2026

(54) ZERO-KNOWLEDGE SOCIAL GRAPH MANAGEMENT WITH SESSION-REVEALED IDENTITIES

(71) Applicant: Amod Ashok Dange, Mountain View, CA (US)

(72) Inventor: Amod Ashok Dange, Mountain View, CA (US)

(21) Appl. No.: 19/411,598

(22) Filed: Dec. 8, 2025

Related U.S. Application Data
(63) Continuation-in-part of application No. 19/361,234, filed on Oct. 17, 2025.
Application No. 19/361,234 is a continuation-in-part of application No. 18/535,512, filed on Dec. 11, 2023, now Pat. No. 12,476,814.
(60) Provisional application No. 63/431,753, filed on Dec. 12, 2022.

(51) Int. Cl. H04L 9/32; H04L 9/08; H04L 9/30

(52) U.S. Cl. CPC H04L 9/3236; H04L 9/0825; H04L 9/0861; H04L 9/30; H04L 9/3218

(57) ABSTRACT

A system and method for zero-knowledge social graph management with session-revealed identities is disclosed. The system is configured for receiving registration requests comprising user communication addresses. The system is further configured to generate cryptographic hashes of communication addresses without storing plaintext addresses. The system is further configured to generate asymmetric key pairs with private keys stored exclusively on user devices. The system is further configured to generate encrypted identity packets containing personally identifiable information encrypted with recipient public keys and transmit connection requests after verifying target existence through hash comparison. The system is further configured to enable recipient-controlled decryption revealing requester identities only when recipients review requests. The system is further configured to generate real-time social connection hashes from communication address hashes and compare them with stored hashes to verify connections without identity exposure, providing zero-knowledge proof of connection.

### CROSS-REFERENCE TO RELATED APPLICATIONS AND PRIORITY

The present application is a Continuation in Part (CIP) application of U.S. Complete application Ser. No. 19/361,234, filed on Oct. 17, 2025 entitled “BIOMETRICALLY SIGNED CRYPTOGRAPHICALLY VERIFIABLE BLOCKCHAIN-ANCHORED CONTRACTS EXECUTED ON A PRIVACY-AWARE MESSAGING PLATFORM” which is a Continuation in Part (CIP) application of U.S. Complete application Ser. No. 18/535,512, filed on Dec. 11, 2023 entitled “System and method of privacy-aware inter-channel communication between a business entity and a person”, which claims priority from U.S. Provisional Application No. 63/431,753 filed on Dec. 12, 2022, entitled “METHOD OF INTEROPERATING BETWEEN EMAIL, TEXT MESSAGING, AND INSTANT MESSAGING”.

### TECHNICAL FIELD

The present invention relates to computer-implemented cryptographic systems for decentralized social networking and privacy-preserving data management. More particularly, it pertains to a distributed computing architecture employing zero-knowledge proof circuits for managing social connection graphs without centralized control or identity exposure.

### BACKGROUND

In the domain of computer-implemented social networking systems, current architectures predominantly employ centralized server infrastructures for managing social connection graphs. These systems utilize relational database management systems executing on multi-core server processors to store user identity records, connection mappings, and relationship metadata. The server infrastructure processes connection requests through authentication modules, validates user credentials against stored records, and maintains indexed data structures representing the social graph topology. Modern implementations deploy load-balanced server clusters with RAM capacities exceeding 512 gigabytes and storage arrays maintaining petabyte-scale datasets containing user profiles, connection records, and interaction logs.

However, existing centralized architectures encounter significant computational and architectural constraints that limit their effectiveness in privacy-preserving operations. Current systems require complete access to unencrypted user identity data for connection validation, resulting in plaintext storage of personally identifiable information across distributed database nodes. The centralized architecture creates single points of failure where compromise of authentication servers or database systems exposes entire social graphs containing millions of user relationships. Query processing for connection discovery operations exhibits computational latency exceeding 200 milliseconds when traversing multi-hop relationship paths across distributed database shards. Memory requirements for maintaining in-memory graph representations consume several gigabytes per million users, limiting scalability on standard server hardware. The architecture lacks cryptographic validation mechanisms, requiring trust in central authorities for connection authenticity verification. Network bandwidth utilization reaches several megabits per second per active user during peak operations, creating throughput bottlenecks at central aggregation points.

Blockchain-based social networking implementations have emerged utilizing distributed ledger technology for storing social connection records. These systems execute consensus protocols across validator nodes, requiring computational proof-of-work or proof-of-stake mechanisms consuming significant processing cycles. Each transaction recording a social connection undergoes validation through cryptographic hashing and merkle tree construction, introducing latency ranging from several seconds to minutes for connection confirmation. The technical constraint manifests in throughput limitations, with typical blockchain networks processing fewer than 100 transactions per second, insufficient for real-time social interaction requirements. Additionally, blockchain architectures store connection data in publicly accessible ledgers, compromising relationship privacy despite pseudonymous addressing schemes.

Federated learning systems for social network analysis distribute computation across edge devices while attempting to preserve user privacy. These implementations partition neural network training across user devices, aggregating gradient updates at central parameter servers. However, the architecture requires transmission of model gradients consuming megabytes of network bandwidth per training iteration, creating communication bottlenecks for resource-constrained mobile devices. The systems lack mechanisms for cryptographic validation of social connections, relying instead on statistical privacy guarantees that degrade with increasing numbers of malicious participants. Computation latency for federated training cycles extends to hours or days, rendering the approach unsuitable for real-time connection management operations.

Existing privacy-preserving cryptographic protocols for set intersection enable two parties to determine common elements without exposing their complete datasets. These protocols employ homomorphic encryption or secure multi-party computation techniques requiring multiple rounds of cryptographic operations between participants. The computational overhead introduces latency exceeding one second for comparing sets containing thousands of elements, limiting scalability to large-scale social graphs. The protocols lack integration with distributed storage mechanisms, requiring coordination through trusted third parties or direct peer-to-peer communication channels that expose network topology and communication patterns.

Therefore, there exists a technical need for a computer-implemented architecture combining cryptographic proof systems with distributed data storage mechanisms to enable privacy-preserving social graph management without centralized control. The required system must achieve connection validation latency under 100 milliseconds while maintaining cryptographic privacy guarantees resistant to relationship inference attacks. The architecture should distribute storage across decentralized node networks with automatic replication mechanisms ensuring data availability without single points of failure. The system requires efficient discovery protocols enabling connection queries with computational overhead linear in the number of direct connections rather than the total graph size, suitable for deployment on resource-constrained mobile computing devices with limited memory and processing capabilities.

### SUMMARY

This summary introduces concepts related to a system and method for zero-knowledge social graph management. The concepts are further described in the detailed description. This summary is not intended to identify essential features of the claimed subject matter nor limit its scope.

In an exemplary embodiment, a system, method, computer program product stored in a non-transitory computer-readable storage medium for zero-knowledge social graph management, with session-revealed identities is disclosed. The system comprises a memory and a processor coupled to the memory. The processor is configured to execute programmed instructions stored in the memory for receiving, by a user registration module, a first registration request, from a first user of a first user device, wherein the first registration request comprises a first user communication address. Further, the processor is configured to execute programmed instructions stored in the memory for receiving, by the user registration module, a second registration request, from a second user of a second user device, wherein the second registration request comprises a second user communication address. Further, the processor is configured to execute programmed instructions stored in the memory for generating, by a hash generation module, a first user communication address hash and a second user communication address hash by hashing the first user communication address and the second user communication address respectively. Further, the processor is configured to execute programmed instructions stored in the memory for generating, by a key generation module, a first user's public key and a first user's private key corresponding to the first user, and a second user's public key and a second user's private key corresponding to the second user. Further, the processor is configured to execute programmed instructions stored in the memory for storing, by a storage module, the first user communication address hash, the second user communication address hash, the first user's public key, and second user's public key on a server, thereby registering the first user and the second user. Further, the processor is configured to execute programmed instructions stored in the memory for generating, by a connection request module, an encrypted first user identity packet comprised of personally identifiable information of the first user, wherein the encrypted first user identity packet is encrypted using the second user's public key. Further, the processor is configured to execute programmed instructions stored in the memory for receiving, by the hash generation module, a communication address of the second user, wherein the communication address of the second user is entered by the first user at the first user device. Further, the processor is configured to execute programmed instructions stored in the memory for hashing, by the hash generation module, the communication address of the second user to generate a second user communication address hash. Further, the processor is configured to execute programmed instructions stored in the memory for receiving, by a connection request module, a connection request from the first user targeting the second user, wherein the connection request comprises the second user communication address hash and the encrypted first user identity packet. Further, the processor is configured to execute programmed instructions stored in the memory for sending, by a notification module, the connection request bundled with the encrypted first user identity packet, to the second user device. Further, the processor is configured to execute programmed instructions stored in the memory for decrypting, by a packet processing module, the first user identity packet with the second user's private key when the second user reviews the connection request, and revealing the personally identifiable information of the first user to the second user on the second user device. Further, the processor is configured to execute programmed instructions stored in the memory for generating, by the hash generation module, a zero-knowledge social connection hash (ZKSC1) when the second user accepts the connection request from the first user, wherein the zero-knowledge social connection hash (ZKSC1) is generated by applying a hashing algorithm to a combination of the first user communication address hash and the second user communication address hash to generate a social connection hash (SC1), generating a random number (R1) for the social connection between the first user and the second user based on a random number generation algorithm, and generating a zero-knowledge social connection hash (ZKSC1) by applying the hashing algorithm to a combination of the social connection hash (SC1) and the random number (R1), wherein the zero-knowledge social connection hash (ZKSC1) provides cryptographic proof of connection existence without enabling reverse-engineering of the underlying communication addresses. Further, the processor is configured to execute programmed instructions stored in the memory for storing, by the storage module, the random number (R1) and the zero-knowledge social connection hash (ZKSC1) on the server, wherein the random number (R1) is stored in association with the zero-knowledge social connection hash (ZKSC1). Further, the processor is configured to execute programmed instructions stored in the memory for verifying, by a verification module, the social connection between the first user and the second user upon initiation of an application session, by regenerating a real-time social connection hash (SC2) based on the first user communication address hash and the second user communication address hash generated in real-time, retrieving the random number (R1) from the server, generating a real-time zero-knowledge social connection hash (ZKSC2) by applying the hashing algorithm to a combination of the real-time social connection hash (SC2) and the random number (R1), and comparing the real-time zero-knowledge social connection hash (ZKSC2) with the zero-knowledge social connection hash (ZKSC1) stored on the server, wherein the social connection is verified when the real-time zero-knowledge social connection hash (ZKSC2) matches the zero-knowledge social connection hash (ZKSC1) stored on the server.

The foregoing general description of the illustrative embodiments and the following detailed description thereof are merely exemplary aspects of the teachings of this invention, and are not restrictive.

### BRIEF DESCRIPTION OF DRAWINGS

The detailed description is described with reference to the accompanying Figures. The same numbers are used throughout the drawings to refer to features and components.

FIG. 1 illustrates a network architecture of a system for zero-knowledge social graph management, in accordance with an embodiment of the present invention;

FIG. 2 is a block diagram showing internal components of the system including processor, memory, and functional modules for cryptographic hash generation and connection verification, in accordance with an embodiment of the present invention;

FIGS. 3A and 3B is a flowchart illustrating a method for zero-knowledge social graph management with session-revealed identities, in accordance with an embodiment of the present invention;

FIG. 4 is a flowchart showing a key generation process with dual options for biometric-based processing and asymmetric algorithm-based generation, in accordance with an embodiment of the present invention;

FIG. 5 is a flowchart illustrating connection request routing for privacy-preserving social discovery, in accordance with an embodiment of the present invention;

FIG. 6 is a flowchart showing address hash verification process by notification module before connection request transmission, in accordance with an embodiment of the present invention;

FIG. 7 is a flowchart depicting performance optimization architecture with machine learning-based predictive caching mechanism, in accordance with an embodiment of the present invention;

FIG. 8 is a sequence diagram showing identity packet encryption, transmission, and decryption flow for session-revealed identity disclosure, in accordance with an embodiment of the present invention; and

FIGS. 9A and 9B is a flowchart illustrating zero-knowledge social connection hash generation process with random number integration and verification process for zero-knowledge proof of connection, in accordance with an embodiment of the present invention.

The foregoing shall be more apparent from the following more detailed description of the invention.

### DETAILED DESCRIPTION

The following description provides exemplary embodiments for illustrative purposes and is not intended to limit the scope or applicability of the invention. Various specific details are provided to enable thorough understanding, but embodiments may be practiced without these details. Well-known processes, structures, and techniques may be shown without unnecessary detail to avoid obscuring the embodiments.

The terms “exemplary” or “demonstrative” mean serving as an example and are not necessarily preferred or advantageous over other designs. References to “one embodiment” or “an embodiment” throughout this specification do not necessarily refer to the same embodiment, and particular features may be combined in any suitable manner. As used herein, singular forms include plural forms unless the context indicates otherwise, and “comprises” or “comprising” specify the presence of stated elements but do not preclude additional elements.

The aspects of the present invention are directed to providing a cryptographic architecture for managing social connections without centralized plaintext storage, implementing privacy-preserving connection request routing mechanisms, and enabling zero-knowledge verification of social relationships through hash-based proof mechanisms with random number integration without requiring identity disclosure to third parties or centralized authorities. The invention generates zero-knowledge social connection hashes by combining social connection hashes with randomly generated numbers, thereby preventing reverse-engineering of underlying communication addresses even when such addresses are publicly available or easily discoverable.

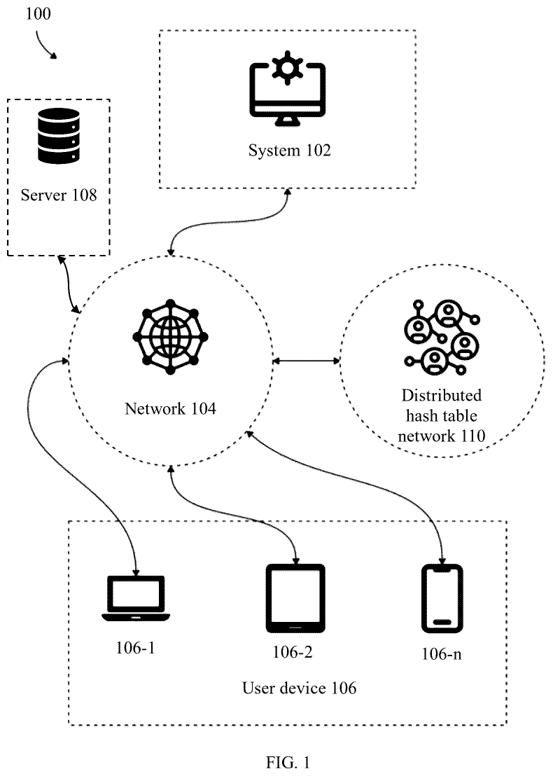

Referring now to FIG. 1, a network implementation (100) of system (102) for zero-knowledge social graph management with session-revealed identities is illustrated, in accordance with an embodiment of the present subject matter. In one embodiment, the system (102) may comprise a processor and a memory. Further, the system (102) may be connected to user devices through a network (104). It may be understood that the system (102) may be communicatively coupled with multiple users through one or more user devices (106-1), (106-2), (106-3), collectively referred to as a user device (106).

The network architecture (100) represents the overall distributed computing environment in which the zero-knowledge social graph management system operates. The network architecture (100) is configured to facilitate secure communication between geographically distributed user devices while maintaining cryptographic privacy protections. The architecture (100) implements a layered protocol stack enabling data transmission across heterogeneous network infrastructures.

The system (102) comprises a computer-implemented platform configured to execute programmed instructions for managing social connections using cryptographic hash-based mechanisms with random number integration for enhanced privacy protection. The system (102) is positioned as a central coordinating entity within the network architecture (100). The system (102) is configured to receive registration requests from users, generate cryptographic hashes of communication addresses, manage public key infrastructure, route connection requests, generate zero-knowledge social connection hashes by combining social connection hashes with randomly generated numbers, store random numbers in association with zero-knowledge social connection hashes, and verify social connections using zero-knowledge proof mechanisms by regenerating social connection hashes, retrieving stored random numbers, and comparing regenerated zero-knowledge social connection hashes with stored values. The system (102) is communicatively coupled to the network (104) via standard network interfaces supporting TCP/IP protocol communication. In some embodiments, the system (102) is implemented using distributed server infrastructure comprising multiple computing nodes operating in a coordinated manner to provide high availability and fault tolerance. In other embodiments, the system (102) may be implemented as a cloud-based service deployed across multiple geographic regions to reduce network latency for geographically dispersed users.

The network (104) comprises communication infrastructure enabling data transmission between the system (102) and the user devices (106). The network (104) is positioned as the communication medium interconnecting all components within the architecture (100). The network (104) is configured to transport encrypted data packets, connection requests, identity packets, verification messages, and cryptographic materials including zero-knowledge social connection hashes and random numbers between endpoints. The network (104) provides bidirectional communication channels supporting the exchange of cryptographic materials and social connection data. In some embodiments, the network (104) comprises the Internet utilizing standard Internet Protocol routing. In other embodiments, the network (104) may comprise a cellular communication network supporting mobile devices through technologies including but not limited to CDMA, GSM, WCDMA, CDMA-2000, UMTS, 3G, 4G, 5G, and subsequent generation mobile network standards.

In one embodiment, the network (104) may support communication over one or more types of networks in accordance with the described embodiments. For example, the network (104) may support communications over a Wide Area Network (WAN), the Internet, a telephone network including analog, digital, POTS, PSTN, ISDN, and xDSL technologies, a mobile telephone network including CDMA, GSM, NDAC, TDMA, E-TDMA, NAMPS, WCDMA, CDMA-2000, UMTS, 3G, 4G, and 5G technologies, a radio network, a television network, a cable network, an optical network including PON, a satellite network including VSAT, a packet-switched network, a circuit-switched network, a public network, a private network, and other wired or wireless communications networks configured to carry data. The network (104) may support wireless local area network (WLAN) and wireless metropolitan area network (WMAN) data communications functionality in accordance with Institute of Electrical and Electronics Engineers (IEEE) standards, protocols, and variants such as IEEE 802.11 standards commonly referred to as WiFi, IEEE 802.16 standards commonly referred to as WiMAX, IEEE 802.20x standards commonly referred to as Mobile-Fi, and other wireless communication standards.

The set of user devices (106) comprises electronic computing devices operated by individual users for accessing the zero-knowledge social graph management system. The user devices (106) are positioned at the edge of the network architecture (100) as client endpoints initiating requests and receiving responses from the system (102). The first user device (106-1) represents a computing device operated by a first user seeking to establish social connections with other users. The second user device (106-2) represents a computing device operated by a second user who may receive connection requests from the first user. The user devices (106) are configured to capture user input including communication addresses entered manually by users, generate and store private cryptographic keys locally on device storage, encrypt identity packets using public keys of other users, decrypt identity packets received from other users using locally stored private keys, and display personally identifiable information of requesting users upon decryption. In some embodiments, the user devices (106) may comprise smartphones, tablet computers, laptop computers, desktop computers, wearable computing devices, or any other electronic device capable of network communication and cryptographic operations. The user devices (106) implement secure storage mechanisms including hardware security modules, secure enclaves, or trusted execution environments for protecting private key material from unauthorized access or extraction.

In some embodiments, each user device (106) executes client application software providing user interfaces for registration, connection request generation, connection request review, and connection verification operations. The client application software on the first user device (106-1) enables the first user to enter a communication address of the second user, generates connection requests containing encrypted identity packets, and transmits the requests to the system (102) for routing to the second user device (106-2). The client application software on the second user device (106-2) receives connection requests, decrypts identity packets using the second user's private key stored locally on the device, displays personally identifiable information of the first user to the second user, and captures acceptance or rejection input from the second user in response to the connection request.

The server (108) comprises computing infrastructure configured to provide persistent storage for cryptographic materials and social connection data. The server (108) is positioned within the network architecture (100) as a data repository accessed by the system (102) during registration, connection establishment, and verification operations. The server (108) is configured to store communication address hashes generated during user registration, public keys associated with registered users, random numbers generated for social connections, zero-knowledge social connection hashes generated by combining social connection hashes with random numbers, and associations between random numbers and their corresponding zero-knowledge social connection hashes. In an exemplary embodiment, the server (108) may implement storage using distributed hash table networks (110) enabling decentralized data storage and retrieval. However, any other type of storage system, database architecture, or distributed data structure including but not limited to relational databases, NoSQL databases, object storage systems, blockchain-based storage, or cloud storage services may be used without departing from the scope of the invention. In some embodiments, the server (108) implements replication mechanisms distributing data across multiple physical storage nodes to provide fault tolerance and data availability guarantees. In other embodiments, the server (108) may implement encryption-at-rest mechanisms encrypting stored data using symmetric encryption keys managed by the system (102), providing additional security protections for stored cryptographic materials and social connection data.

In an exemplary embodiment, the system (102) may utilize distributed hash table networks (110) for connection request routing and data storage. However, any other type of storage system, routing mechanism, or distributed data structure may be used without departing from the scope of the invention.

In one embodiment, the system (102) is designed to provide privacy-preserving social connection management without maintaining centralized repositories of plaintext user identity data or unencrypted social graph structures. The system (102) includes various modules for handling different aspects of user registration, cryptographic key generation, hash computation, random number generation for zero-knowledge proof enhancement, connection request processing, identity packet encryption and decryption, and connection verification with zero-knowledge social connection hash mechanisms. The system (102) also incorporates advanced technologies such as zero-knowledge proof mechanisms with random number integration for verifying social connections without enabling reverse-engineering of underlying communication addresses, asymmetric public-key cryptography for enabling recipient-controlled identity disclosure, and connection request routing for privacy-preserving social discovery.

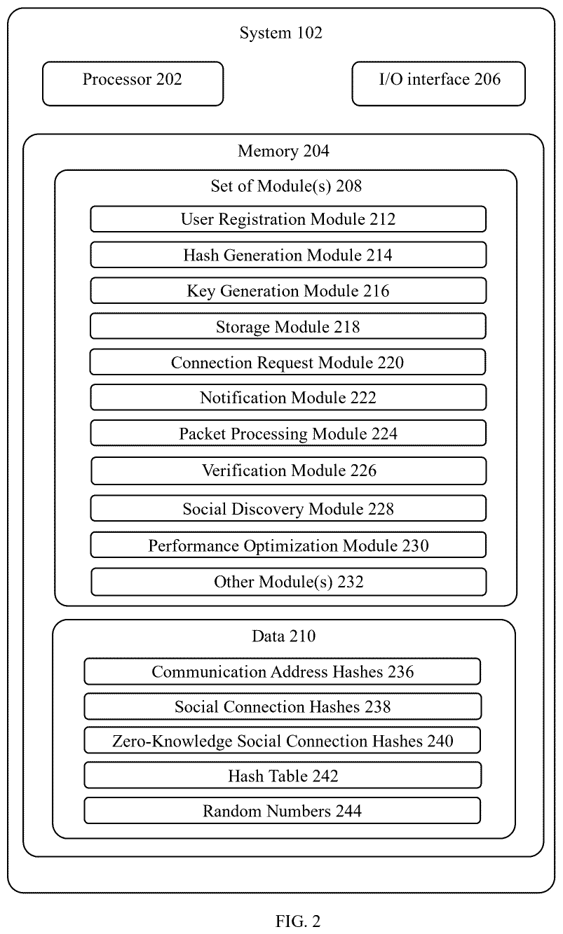

Overall, the system (102) aims to provide a comprehensive solution for managing social graphs with cryptographic privacy protections, enabling users to establish verifiable social connections while maintaining control over identity disclosure and preventing centralized surveillance of relationship patterns or reverse-engineering attacks on connection data. The specific details of the internal system components, cryptographic operations including random number generation and zero-knowledge social connection hash creation, connection establishment workflows, and verification mechanisms will be further elaborated in the description of subsequent figures. The user registration process and internal system architecture are further illustrated with the block diagram in FIG. 2.

Referring now to FIG. 2, various components of the system (102) are illustrated, in accordance with an embodiment of the present subject matter. As shown, the system (102) may include at least one processor (202), an I/O Interface (206), and a memory (204). The memory (204) consists of a set of modules (208) and data (210). The set of modules (208) may include a user registration module (212), a hash generation module (214), a key generation module (216), a storage module (218), a connection request module (220), a notification module (222), a packet processing module (224), a verification module (226), a social discovery module (228), a Performance Optimization Module (230), and other modules (232). In one embodiment, the at least one processor (202) is configured to fetch and execute computer-readable instructions stored in the memory (204) corresponding to each module.

The processor (202) comprises a central processing unit configured to execute programmed instructions for implementing the zero-knowledge social graph management functionality. The processor (202) is positioned as the primary computational component within the system (102). The processor (202) is configured to fetch instructions from the memory (204), decode instruction opcodes, execute arithmetic and logical operations, and coordinate data movement between system components. The processor (202) performs cryptographic hash computations including generation of communication address hashes, social connection hashes, and zero-knowledge social connection hashes, random number generation operations for enhancing zero-knowledge proof security, asymmetric key generation operations, encryption and decryption operations when processing identity packets, and comparison operations during connection verification. The processor (202) is operatively coupled to the memory (204) through a system bus providing high-bandwidth data transfer, and to the I/O interface (206) for communicating with external devices. In some embodiments, the processor (202) comprises a multi-core processor architecture with multiple processing cores operating in parallel to improve throughput when handling concurrent user requests. In other embodiments, the processor (202) may be supplemented with specialized hardware accelerators including cryptographic coprocessors for accelerating hash computations, random number generation, and encryption operations, thereby reducing computational latency for cryptographic functions from approximately hundreds of milliseconds to approximately tens of milliseconds.

The memory (204) comprises computer-readable storage media configured to store programmed instructions and data structures utilized by the processor (202). The memory (204) is positioned as the primary data storage component within the system (102) architecture. The memory (204) is configured to persistently or temporarily store executable code implementing the functional modules, intermediate computation results, cryptographic keys during processing operations, random numbers (244) generated for social connections, and data structures representing communication address hashes (236), social connection hashes (238), zero-knowledge social connection hashes (240), and associations between random numbers and zero-knowledge social connection hashes (240). The memory (204) provides read and write access to the processor (202) for retrieving instructions and storing computation results. The memory (204) is directly coupled to the processor (202) through memory bus interfaces providing high-speed data access with latencies measured in nanoseconds. In one embodiment, the memory (204) may include any computer-readable medium known in the art including, for example, volatile memory such as static random-access memory (SRAM) and dynamic random-access memory (DRAM), and non-volatile memory such as read-only memory (ROM), erasable programmable ROM, flash memories, hard disks, optical disks, and memory cards. In some embodiments, the memory (204) comprises a hierarchical storage architecture with fast volatile RAM for active processing and slower non-volatile storage for persistent data, optimizing the trade-off between access speed and data persistence requirements.

The I/O Interface (206) comprises hardware and software components configured to facilitate communication between the system (102) and external entities including user devices and networks. The I/O Interface (206) is positioned as the communication boundary component of the system (102). The I/O Interface (206) is configured to receive incoming data packets from the network (104), transmit outgoing data packets to user devices (106), perform protocol conversion between internal data formats and network transmission formats, and manage connection state for active communication sessions. The I/O Interface (206) is operatively coupled to both the processor (202) for data exchange and to the network (104) for external communication. In some embodiments, the I/O Interface (206) implements network interface controllers supporting Ethernet protocols for wired communication or wireless communication protocols for wireless connectivity. In other embodiments, the I/O Interface (206) may include application programming interface (API) endpoints enabling programmatic access to system functionality through standard web service protocols including REST and GraphQL.

The set of modules (208) comprises a collection of functional software components implementing distinct aspects of the zero-knowledge social graph management system. The set of modules (208) is logically organized within the memory (204) as executable instructions. The set of modules (208) is configured to provide modular functionality enabling separation of concerns for registration, cryptographic operations including random number generation and zero-knowledge social connection hash creation, connection management, and verification processes with zero-knowledge proof mechanisms. Each module within the set of modules (208) can be invoked by the processor (202) independently to perform its designated function. In one embodiment, the programmed instructions may include routines, programs, objects, components, data structures, and procedures which perform particular tasks, functions, or implement particular abstract data types.

The user registration module (212) comprises executable instructions configured to process user registration requests and establish user accounts within the system. The user registration module (212) is positioned within the set of modules (208) as the entry point for new user onboarding. The user registration module (212) is configured to receive a first registration request from a first user of a first user device, wherein the first registration request comprises a first user communication address, and to receive a second registration request from a second user of a second user device, wherein the second registration request comprises a second user communication address. The user registration module (212) extracts communication addresses from registration requests, validates the format and authenticity of provided communication addresses, and coordinates with other modules (232) to generate cryptographic materials for registered users. The user registration module (212) is communicatively coupled to the hash generation module (214) for generating hashes of communication addresses, to the key generation module (216) for generating public-private key pairs, and to the storage module (218) for persisting registration data. In some embodiments, the user registration module (212) implements validation logic to verify ownership of provided communication addresses by transmitting verification codes to the provided addresses and confirming user receipt of those codes before completing registration. In other embodiments, the user registration module (212) may implement multi-factor authentication mechanisms requiring users to provide additional verification factors beyond the communication address to enhance security against account creation by unauthorized parties.

The hash generation module (214) comprises executable instructions configured to perform cryptographic hashing operations on communication addresses and generate social connection hashes and zero-knowledge social connection hashes. The hash generation module (214) is positioned within the set of modules (208) as the cryptographic transformation component. The hash generation module (214) is configured to generate a first user communication address hash and a second user communication address hash by hashing the first user communication address and the second user communication address respectively using cryptographic hash functions. The hash generation module (214) applies one-way hash algorithms that transform variable-length input strings into fixed-length hash values in a manner that is computationally infeasible to reverse. The hash generation module (214) is further configured to receive a communication address of a second user entered by a first user at the first user device, and to hash the communication address of the second user to generate a communication address hash of the second user for connection request targeting. Additionally, the hash generation module (214) is configured to generate a zero-knowledge social connection hash (ZKSC1) when the second user accepts a connection request from the first user, wherein the zero-knowledge social connection hash (ZKSC1) is generated by applying a hashing algorithm to a combination of the first user communication address hash and the second user communication address hash to generate a social connection hash (SC1), and then applying the hashing algorithm to a combination of the social connection hash (SC1) and a random number (R1) generated for the social connection. The hash generation module (214) is further configured to generate a real-time zero-knowledge social connection hash (ZKSC2) during verification operations by combining regenerated real-time social connection hash (SC2) with retrieved random numbers (R1).

The hash generation module (214) is communicatively coupled to the user registration module (212) for receiving communication addresses during registration, to the storage module (218) for providing generated hashes and random numbers for storage, and to the verification module (226) for generating real-time hashes during connection verification. In some embodiments, the hash generation module (214) implements SHA-256 cryptographic hash algorithm providing 256-bit hash outputs with computational complexity making preimage attacks infeasible with current computing technology. In other embodiments, the hash generation module (214) may implement alternative cryptographic hash functions including SHA-3, BLAKE2, or other collision-resistant hash functions approved for cryptographic applications, selecting hash functions based on performance requirements and security characteristics. In some embodiments, the hash generation module (214) applies deterministic hashing ensuring that identical input communication addresses always produce identical hash outputs, enabling consistent connection verification across different time points. The hash generation module (214) also implements random number generation functionality, utilizing cryptographically secure random number generation algorithms to produce random numbers that serve as salts for zero-knowledge social connection hashes, preventing attackers from reverse-engineering social connections by hashing known communication address combinations.

The key generation module (216) comprises executable instructions configured to generate asymmetric cryptographic key pairs for users. The key generation module (216) is positioned within the set of modules (208) as the public-key infrastructure component. The key generation module (216) is configured to generate a first user's public key and a first user's private key corresponding to the first user, and a second user's public key and a second user's private key corresponding to the second user. The key generation module (216) implements asymmetric key generation algorithms producing mathematically related key pairs where data encrypted with the public key can only be decrypted with the corresponding private key. The key generation module (216) is communicatively coupled to the user registration module (212) for receiving key generation requests during user registration, to the storage module (218) for providing public keys for server storage, and to user devices (106) for transmitting private keys for local storage. In some embodiments, the first user's public key, the first user's private key, the second user's public key, and the second user's private key are generated based on processing of biometric factors of the first user and the second user. The biometric factors may comprise one or more of face, fingerprint, iris, retina, or voice biometric measurements captured from users. The key generation module (216) processes biometric data through feature extraction algorithms producing stable biometric templates, applies fuzzy extraction techniques to generate consistent cryptographic key material from biometric measurements that may vary slightly between captures, and derives cryptographic keys from the processed biometric features. In other embodiments, the first user's public key, the first user's private key, the second user's public key, and the second user's private key are generated based on an asymmetric key generation algorithm independent of biometric data. The key generation module (216) generates random or pseudorandom numbers to serve as private key material, applies modular exponentiation or elliptic curve point multiplication operations to derive corresponding public keys from private keys, and ensures that the mathematical relationship between public and private keys enables encryption with public keys and decryption with private keys. In some embodiments, RSA key generation is implemented by generating large prime numbers through probabilistic primality testing, computing their product to form the modulus, selecting public exponent values, and computing private exponent values through modular multiplicative inverse operations. The first user's private key and second user's private key are stored at the first user device and the second user device respectively in secure storage areas, while public keys are prepared for server storage.

The storage module (218) comprises executable instructions configured to persist registration data, cryptographic materials, and social connection data to the server. The storage module (218) is positioned within the set of modules (208) as the data persistence component. The storage module (218) is configured to store the first user communication address hash, the second user communication address hash, the first user's public key, and second user's public key on the server (108), thereby registering the first user and the second user in the system without storing plaintext communication addresses that could reveal user identities. The storage module (218) is further configured to store random numbers (R1) generated for social connections in association with corresponding zero-knowledge social connection hash (ZKSC1) on the server (108), enabling subsequent retrieval of random numbers during connection verification operations. The storage module (218) is further configured to store zero-knowledge social connection hash (ZKSC1) on the server (108) when users accept connection requests, organizing the data structures to enable efficient retrieval during connection verification operations. The storage module (218) implements database interface protocols for inserting, updating, querying, and deleting records in the data repository. The storage module (218) is communicatively coupled to the hash generation module (214) for receiving communication address hashes (236), social connection hashes (238), zero-knowledge social connection hashes (240), and random numbers (244) to store, to the key generation module (216) for receiving public keys to store, and to the server (108) for executing storage operations. In some embodiments, the storage module (218) implements structured query language (SQL) interfaces for interacting with relational database management systems, constructing parameterized queries to prevent SQL injection attacks, and managing database transactions to ensure atomicity of multi-step storage operations. In other embodiments, the storage module (218) may implement NoSQL database interfaces optimized for key-value storage patterns. In an exemplary embodiment, the storage module (218) may utilize hash tables as the underlying data structure for storing zero-knowledge social connection hashes with constant-time lookup complexity. However, any other type of storage system, database architecture, or distributed data structure including but not limited to relational databases, document databases, graph databases, or blockchain-based storage may be used without departing from the scope of the invention. The storage module (218) maintains associations between random numbers and their corresponding zero-knowledge social connection hashes, enabling the verification module to retrieve the correct random number when verifying a specific connection.

The connection request module (220) comprises executable instructions configured to generate encrypted identity packets and process connection requests between users. The connection request module (220) is positioned within the set of modules (208) as the connection initiation component. The connection request module (220) is configured to generate an encrypted first user identity packet comprised of personally identifiable information of the first user, wherein the encrypted first user identity packet is encrypted using the second user's public key retrieved from the server (108). The personally identifiable information may comprise a profile photo, a name, a username, and any other personally identifying information that enables the second user to identify who is requesting to connect. The connection request module (220) retrieves the first user's personally identifiable information from storage or user input, retrieves the second user's public key from the server (108) using the second user communication address hash as the lookup key, applies asymmetric encryption algorithm using the second user's public key to encrypt the identity packet, and generates the encrypted identity packet that can only be decrypted using the second user's private key stored on the second user device. The connection request module (220) is further configured to receive a connection request from the first user targeting the second user, wherein the connection request comprises the communication address hash of the second user and the encrypted first user identity packet. The connection request module (220) is communicatively coupled to the hash generation module (214) for receiving communication address hashes, to the storage module (218) for retrieving public keys, and to the notification module (222) for delivering connection requests to target users. In some embodiments, the connection request module (220) implements RSA-OAEP encryption algorithm providing security against chosen-plaintext and chosen-ciphertext attacks during identity packet encryption. In other embodiments, the connection request module (220) may implement elliptic curve integrated encryption scheme (ECIES) for more efficient encryption on resource-constrained devices, reducing encryption overhead compared to traditional RSA encryption.

The notification module (222) comprises executable instructions configured to transmit connection requests to target users and verify target user existence. The notification module (222) is positioned within the set of modules (208) as the message delivery component. The notification module (222) is configured to send the connection request bundled with the encrypted first user identity packet to the second user device. The notification module (222) determines the appropriate delivery mechanism for reaching the second user device, formats the connection request according to transmission protocol requirements, and transmits the bundled request through the network (104) to the second user device (106-2). In some embodiments, the notification module (222) is configured to compare the communication address hash of the second user generated in real-time with the second user communication address hash stored on the server (108) and send the connection request when the communication address hash of the second user generated in real-time matches with the second user communication address hash stored on the server (108), thereby verifying that the target user exists in the system before attempting delivery. The notification module (222) performs a lookup operation in the server (108) storage to determine if a user with the specified communication address hash is registered, and only proceeds with connection request delivery if a matching hash is found. The notification module (222) is communicatively coupled to the connection request module (220) for receiving connection requests to deliver, to the storage module (218) for querying stored communication address hashes, and to the I/O Interface (206) for transmitting requests across the network. In some embodiments, the notification module (222) implements push notification protocols enabling real-time delivery of connection requests to user devices without requiring users to poll the server for new requests, reducing latency between connection request initiation and user notification. In other embodiments, the notification module (222) may implement queued message delivery with retry mechanisms, storing pending connection requests in a queue when target devices are offline and attempting redelivery when devices reconnect to the network, ensuring reliable delivery despite intermittent network connectivity.

The packet processing module (224) comprises executable instructions configured to decrypt encrypted identity packets on user devices when users review connection requests. The packet processing module (224) may be positioned within the set of modules (208) as server-side coordination logic, or alternatively may be implemented as client-side executable code running on user devices (106). The packet processing module (224) is configured to decrypt the first user identity packet with the second user's private key when the second user reviews the connection request, and to reveal the personally identifiable information of the first user to the second user on the second user device. The packet processing module (224) retrieves the second user's private key from secure storage on the second user device (106-2), applies asymmetric decryption algorithm using the private key to decrypt the encrypted identity packet, extracts the personally identifiable information from the decrypted packet, and renders the information on the display of the second user device enabling the second user to view who is requesting to connect. The packet processing module (224) is communicatively coupled to secure storage areas on user devices for accessing private keys, and to user interface components for displaying decrypted identity information. In some embodiments, the packet processing module (224) implements RSA-OAEP decryption algorithm providing security against chosen-ciphertext attacks during the decryption process. In other embodiments, the packet processing module (224) may implement elliptic curve-based decryption algorithms for devices with limited computational resources, reducing decryption time from approximately several hundred milliseconds to approximately tens of milliseconds on mobile processors. The packet processing module (224) ensures that decryption occurs only on the second user device and only when the second user actively chooses to review the connection request, maintaining privacy by preventing premature or unauthorized identity disclosure.

The verification module (226) comprises executable instructions configured to verify social connections between users during application sessions using zero-knowledge proof mechanisms with random number integration. The verification module (226) is positioned within the set of modules (208) as the connection authentication component. The verification module (226) is configured to verify the social connection between the first user and the second user upon initiation of an application session by regenerating a real-time social connection hash (SC2) based on the first user communication address hash and the second user communication address hash generated in real-time, retrieving the random number (R1) from the server (108), generating a real-time zero-knowledge social connection hash (ZKSC2) by applying the hashing algorithm to a combination of the real-time social connection hash (SC2) and the random number (R1), and comparing the real-time zero-knowledge social connection hash (ZKSC2) with the zero-knowledge social connection hash (ZKSC1) stored on the server (108), wherein the social connection is verified when the real-time zero-knowledge social connection hash (ZKSC2) matches the zero-knowledge social connection hash (ZKSC1) stored on the server (108). The verification module (226) retrieves the communication address hashes (236) for both users from server storage, coordinates with the hash generation module (214) to generate the real-time social connection hash (SC2), retrieves the associated random number (R1) from server storage using the connection identifier or user pair identifier as the lookup key, coordinates with the hash generation module (214) to generate the real-time zero-knowledge social connection hash (ZKSC2), retrieves the stored zero-knowledge social connection hash (ZKSC1) from server storage, performs a comparison operation between ZKSC2 and ZKSC1, and determines that a valid connection exists if the hashes match. The verification module (226) produces a zero-knowledge proof of connection without revealing the underlying identities or communication addresses of the connected parties and without enabling reverse-engineering attacks, as the verification relies on hash comparison involving the secret random number that attackers cannot access or predict. The verification module (226) is communicatively coupled to the hash generation module (214) for generating real-time hashes, to the storage module (218) for retrieving stored zero-knowledge social connection hashes and random numbers, and to application logic requiring connection verification before granting access to features dependent on social connections. In some embodiments, the verification module (226) implements constant-time comparison algorithms when comparing hash values to prevent timing side-channel attacks that could potentially leak information about hash contents through variation in comparison execution time. In other embodiments, the verification module (226) may cache verification results for a limited time period to reduce the computational overhead of repeated verification operations for the same connection within a single application session, trading off slight increases in memory usage for improved performance in connection-heavy usage scenarios.

The social discovery module (228) comprises executable instructions configured to implement privacy-preserving connection request routing. The social discovery module (228) is positioned within the set of modules (208) as the routing component. In some embodiments, the system (102) further comprises the social discovery module (228) with a connection request routing mechanism that transmits connection requests without revealing source addresses or destination addresses of the first user device or the second user device. In an exemplary embodiment, the social discovery module (228) may route connection requests through distributed hash table networks (110) implementing onion routing or layered encryption protocols ensuring that no single routing node knows both source and destination addresses. However, any other type of routing mechanism, anonymization network, privacy-preserving protocol, or distributed communication architecture including but not limited to mix networks, Tor-style onion routing, I2P anonymous networking, or direct peer-to-peer communication may be used without departing from the scope of the invention. The social discovery module (228) applies multiple layers of encryption to connection requests, routes requests through multiple intermediate nodes, and ensures that each routing node can only decrypt one layer of encryption revealing only the next hop address without exposing the ultimate source or destination. The social discovery module (228) is communicatively coupled to the connection request module (220) for receiving connection requests to route, to the notification module (222) for coordinating delivery to target users, and to network routing infrastructure for transmitting requests through privacy-preserving channels.

The Performance Optimization Module (230) comprises executable instructions configured to predict connection verification patterns and optimize system performance through predictive caching. The Performance Optimization Module (230) is positioned within the set of modules (208) as the performance enhancement component. In some embodiments, the system (102) further comprises the Performance Optimization Module (230), wherein the Performance Optimization Module (230) employs machine learning algorithms for predicting access patterns and preloading frequently accessed social connection data including zero-knowledge social connection hashes and associated random numbers into cache memory, wherein the machine learning algorithms analyze temporal access patterns and social graph topology for prediction optimization. The Performance Optimization Module (230) observes historical verification patterns recording which connections are verified at which times, applies machine learning models including neural networks, decision trees, or gradient boosting algorithms to predict future verification requests based on observed patterns, and proactively loads predicted zero-knowledge social connection hashes and their associated random numbers into high-speed cache memory before verification requests occur. The Performance Optimization Module (230) is communicatively coupled to the verification module (226) for observing verification patterns, to the storage module (218) for retrieving connection data for caching, and to cache memory subsystems for managing cached data. The Performance Optimization Module (230) reduces verification latency from approximately tens or hundreds of milliseconds for server storage access to approximately nanoseconds or microseconds for cache memory access, improving user experience by enabling near-instantaneous connection verification for predicted access patterns.

The other modules (232) comprise additional functional components that may be included in the system (102) for supporting various auxiliary functions. The other modules (232) may include user interface modules for rendering graphical user interfaces on user devices, logging modules for recording system events and security audit trails, analytics modules for tracking system usage patterns and performance metrics, security modules for implementing additional security controls such as rate limiting and intrusion detection, and any other supporting modules necessary for complete system functionality. The other modules (232) are positioned within the set of modules (208) as auxiliary components supporting the core zero-knowledge social graph management functionality.

The data (210) comprises the information stored and processed by the system (102) during operation. The data (210) is logically organized within the memory (204) as structured data elements. The data (210) includes various categories of information processed by the functional modules.

The communication address hashes (236) comprise cryptographic hash values derived from user communication addresses. The communication address hashes (236) represent hashed versions of email addresses, phone numbers, or proxy communication addresses provided by users during registration. The communication address hashes (236) are stored on the server (108) as the primary user identifiers, enabling user lookup and connection request targeting without storing plaintext communication addresses that could reveal user identities. Each communication address hash is a fixed-length value typically 256 bits in length when SHA-256 hashing is used, providing computational infeasibility of reverse-engineering the original communication address from the hash value.

The social connection hashes (238) comprise intermediate cryptographic hash values generated by combining communication address hashes of two connected users. The social connection hashes (238) are generated by applying hashing algorithms to combinations of first user communication address hashes and second user communication address hashes, producing hash values representing social connections. The social connection hashes (238) serve as intermediate values in the zero-knowledge social connection hash generation process, being combined with random numbers to produce zero-knowledge social connection hashes.

The zero-knowledge social connection hashes (240) comprise cryptographic hash values generated by combining social connection hashes with random numbers, providing enhanced privacy protection against reverse-engineering attacks. The zero-knowledge social connection hashes (240) are generated by applying hashing algorithms to combinations of social connection hashes and random numbers, producing hash values that prove connection existence without enabling attackers to reverse-engineer the underlying communication addresses even when such addresses are publicly available. The zero-knowledge social connection hashes (240) are stored on the server (108) in association with their corresponding random numbers, enabling verification operations to regenerate and compare zero-knowledge social connection hashes to validate social connections.

The random numbers (244) comprise cryptographically secure random values generated for each social connection to serve as salts in zero-knowledge social connection hash generation. The random numbers (244) are generated using random number generation algorithms providing sufficient entropy to prevent prediction or brute-force attacks. Each random number is associated with a specific social connection and its corresponding zero-knowledge social connection hash, stored on the server (108) to enable retrieval during verification operations. The random numbers (244) prevent attackers from reverse-engineering social connections by hashing known communication address combinations, as the attacker cannot predict or access the random number required to generate valid zero-knowledge social connection hashes.

In an embodiment, the hash table (242) comprises a data structure optimized for storing and retrieving zero-knowledge social connection hashes and their associated random numbers. The hash table (242) implements key-value storage where zero-knowledge social connection hashes or connection identifiers serve as keys enabling constant-time O(1) lookup operations during connection verification. The hash table (242) is stored on the server (108) and accessed during verification module (226) operations to retrieve both zero-knowledge social connection hashes and their associated random numbers.

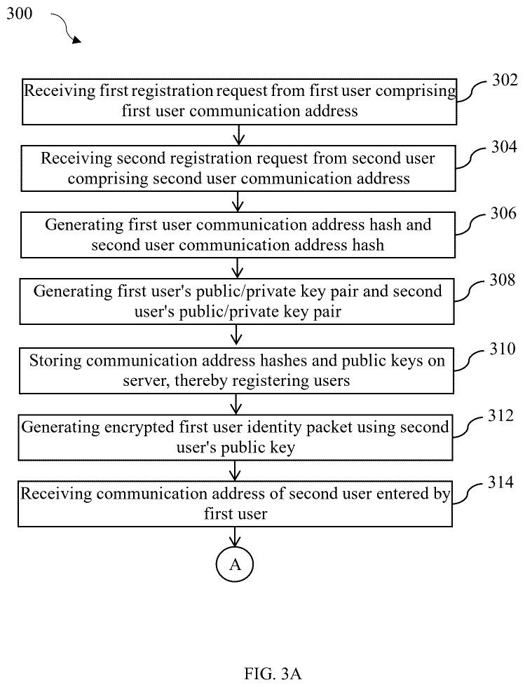

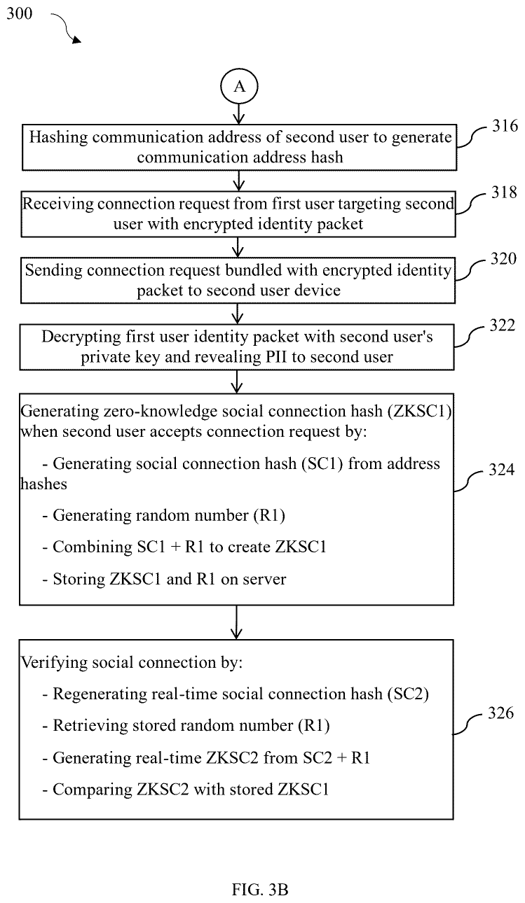

Referring now to FIGS. 3A and 3B, a flowchart of a computer-implemented method (300) for zero-knowledge social graph management with session-revealed identities is illustrated, in accordance with an embodiment of the present invention. The method (300) provides a systematic process for establishing and verifying social connections using cryptographic mechanisms with random number-enhanced zero-knowledge proofs without centralized plaintext storage of user identities.

At step (302), the method (300) includes receiving, by a user registration module (212), a first registration request from a first user of a first user device, wherein the first registration request comprises a first user communication address. The processor (202) retrieves instructions from the memory (204) corresponding to the user registration module (212), receives network packets transmitted from the first user device (106-1) through the network (104) and I/O interface (206), extracts the first user communication address from the registration request payload, and stores the address in temporary memory for processing.

At step (304), the method (300) includes receiving, by the user registration module (212), a second registration request from a second user of a second user device, wherein the second registration request comprises a second user communication address. The processor (202) executes similar operations as step (302) for the second user, enabling parallel registration of multiple users without interdependencies between registration operations.

At step (306), the method (300) includes generating, by a hash generation module (214), a first user communication address hash and a second user communication address hash by hashing the first user communication address and the second user communication address respectively. The processor (202) executes instructions corresponding to the hash generation module (214) to perform cryptographic hash computations, applying cryptographic hash algorithms that transform variable-length communication addresses into fixed-length hash values in a computationally infeasible-to-reverse manner.

At step (308), the method (300) includes generating, by a key generation module (216), a first user's public key and a first user's private key corresponding to the first user, and a second user's public key and a second user's private key corresponding to the second user. The processor (202) executes instructions corresponding to the key generation module (216) to perform asymmetric key pair generation. In some embodiments, the first user's public key, the first user's private key, the second user's public key, and the second user's private key are generated based on processing of biometric factors of the first user and the second user, wherein the biometric factors comprise one or more of face, fingerprint, iris, retina, or voice. In other embodiments, the keys are generated based on an asymmetric key generation algorithm independent of biometric data. The first user's private key and second user's private key are stored at the first user device and the second user device respectively.

At step (310), the method (300) includes storing, by a storage module (218), the first user communication address hash, the second user communication address hash, the first user's public key, and second user's public key on a server (108), thereby registering the first user and the second user. The processor (202) executes the storage module (218) to persist registration data without storing plaintext communication addresses. The first user communication address and the second user communication address are selected from email addresses, phone numbers or proxy communication addresses.

At step (312), the method (300) includes generating, by a connection request module (220), an encrypted first user identity packet comprised of personally identifiable information of the first user, wherein the encrypted first user identity packet is encrypted using the second user's public key. The personally identifiable information comprises a profile photo, a name, a username, and any other personally identifying information, enabling the second user to identify who is requesting to connect.

At step (314), the method (300) includes receiving, by the hash generation module (214), a communication address of the second user, wherein the communication address of the second user is entered by the first user at the first user device. The processor (202) receives user input captured at the first user device (106-1) where the first user manually enters or selects the communication address of the second user they wish to connect with.

At step (316), the method (300) includes hashing, by the hash generation module (214), the communication address of the second user to generate a communication address hash of the second user. The processor (202) applies the same cryptographic hash algorithm used during registration to enable identification of the target user without transmitting plaintext communication addresses.

At step (318), the method (300) includes receiving, by a connection request module (220), a connection request from the first user targeting the second user, wherein the connection request comprises the communication address hash of the second user and the encrypted first user identity packet. The processor (202) receives the connection request structured as a data packet containing both elements for transmission to the target user.

At step (320), the method (300) includes sending, by a notification module (222), the connection request bundled with the encrypted first user identity packet to the second user device. The processor (202) executes instructions corresponding to the notification module (222) to deliver the connection request. In some embodiments, the notification module (222) is configured to compare the communication address hash of the second user with the second user communication address hash stored on the server and send the connection request when the communication address hash of the second user matches with the second user communication address hash, thereby verifying target user existence before attempting delivery.

At step (322), the method (300) includes decrypting, by a packet processing module (224), the first user identity packet with the second user's private key when the second user reviews the connection request, and revealing the personally identifiable information of the first user to the second user on the second user device. The processor on the second user device (106-2) retrieves the second user's private key from secure storage, applies asymmetric decryption algorithm, extracts the personally identifiable information, and renders it on the device display, enabling an informed decision about connection acceptance.

At step (324), the method (300) includes generating, by the hash generation module (214), a zero-knowledge social connection hash (ZKSC1) when the second user accepts the connection request from the first user. The processor (202) executes the hash generation module (214) when acceptance input is received from the second user. The zero-knowledge social connection hash (ZKSC1) is generated by applying a hashing algorithm to a combination of the first user communication address hash and the second user communication address hash to generate a social connection hash (SC1), generating a random number (R1) for the social connection between the first user and the second user based on a random number generation algorithm, and generating the zero-knowledge social connection hash (ZKSC1) by applying the hashing algorithm to a combination of the social connection hash (SC1) and the random number (R1). The zero-knowledge social connection hash (ZKSC1) provides cryptographic proof of connection existence without enabling reverse-engineering of the underlying communication addresses, as attackers cannot predict or access the random number required to generate valid zero-knowledge social connection hashes even when communication addresses are publicly available. The processor (202) stores, by the storage module (218), the random number (R1) and the zero-knowledge social connection hash (ZKSC1) on the server (108), wherein the random number (R1) is stored in association with the zero-knowledge social connection hash (ZKSC1) enabling subsequent retrieval during verification operations. In an exemplary embodiment, the zero-knowledge social connection hash is stored in a hash table on the server (108). However, any other type of storage system, database architecture, or distributed data structure may be used without departing from the scope of the invention.

At step (326), the method (300) includes verifying, by a verification module (226), the social connection between the first user and the second user upon initiation of an application session. The processor (202) executes instructions corresponding to the verification module (226) when users initiate application sessions requiring connection verification. The verification is performed by regenerating a real-time social connection hash (SC2) based on the first user communication address hash and the second user communication address hash generated in real-time, retrieving the random number (R1) from the server (108), generating a real-time zero-knowledge social connection hash (ZKSC2) by applying the hashing algorithm to a combination of the real-time social connection hash (SC2) and the random number (R1), and comparing the real-time zero-knowledge social connection hash (ZKSC2) with the zero-knowledge social connection hash (ZKSC1) stored on the server (108), wherein the social connection is verified when the real-time zero-knowledge social connection hash (ZKSC2) matches the zero-knowledge social connection hash (ZKSC1) stored on the server (108). The verification process provides cryptographic assurance of connection validity without requiring storage or transmission of user identities and without enabling reverse-engineering attacks on social connections. Upon completion of verification, the application session is authenticated and users are granted access to features requiring verified connections.

In some embodiments, the method (300) further comprises implementing a social discovery module (228) with a connection request routing mechanism that transmits connection requests without revealing source addresses or destination addresses of the first user device or the second user device. In an exemplary embodiment, the connection request routing mechanism may utilize distributed hash table networks (110) implementing privacy-preserving routing protocols. However, any other type of routing mechanism, anonymization network, or distributed communication architecture may be used without departing from the scope of the invention. The processor (202) applies layered encryption protocols to route connection requests through multiple intermediate nodes ensuring that no single routing node knows both source and destination addresses, providing enhanced privacy protection against network traffic analysis attacks.

In some embodiments, the method (300) further comprises employing a Performance Optimization Module (230) that uses machine learning algorithms for predicting access patterns and preloading frequently accessed social connection data including zero-knowledge social connection hashes and associated random numbers into cache memory, wherein the machine learning algorithms analyze temporal access patterns and social graph topology for prediction optimization. The processor (202) observes historical verification patterns, applies machine learning models to predict future verification requests, and proactively loads predicted zero-knowledge social connection hashes and their associated random numbers into high-speed cache memory before verification requests occur, reducing verification latency.

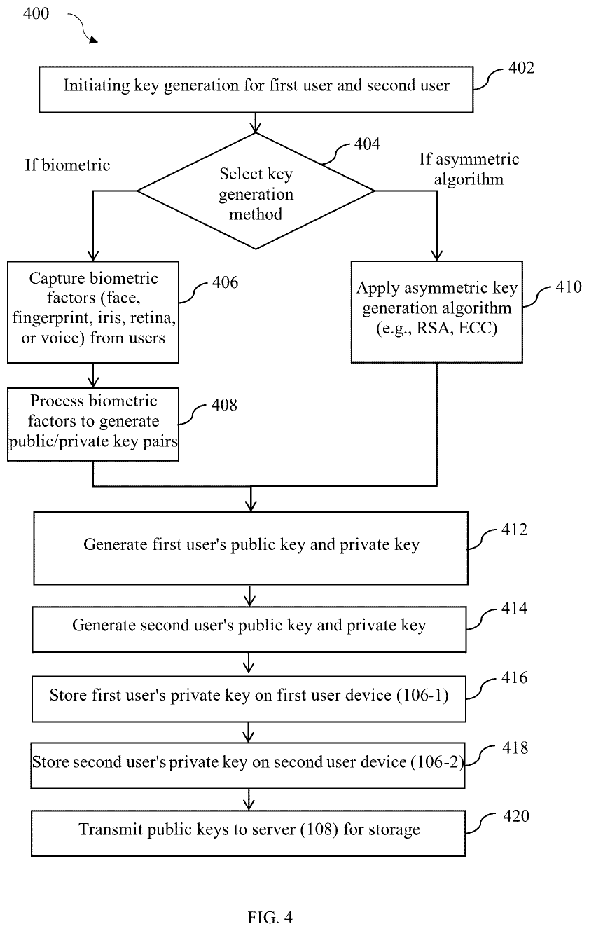

Referring now to FIG. 4, a flowchart of a method (400) illustrating the key generation process with alternative implementation options is shown, in accordance with an embodiment of the present invention.

At step (402), the method (400) includes initiating key generation for a first user and a second user. The processor (202) receives a key generation request triggered by user registration processes, identifying the users for whom key pairs must be generated.

At step (404), the method (400) includes determining the key generation method to employ. The processor (202) evaluates whether biometric-based key generation or asymmetric algorithm-based key generation should be used. This decision may be based on user preferences, device capabilities, security requirements, or system configuration.

At step (406), if biometric processing is selected, the method (400) includes capturing biometric factors from users. The processor on user devices activates biometric sensors for capturing biometric data. The biometric factors comprise one or more of face, fingerprint, iris, retina, or voice measurements.

At step (408), the method (400) includes processing biometric factors to generate public and private key pairs. The processor (202) applies biometric feature extraction algorithms to transform raw biometric data into stable feature vectors, implements fuzzy extraction techniques to generate consistent key material from biometric features that may vary slightly between measurements, applies error correction codes to compensate for measurement noise, and derives cryptographic key material through key derivation functions. The biometric processing ensures that keys can be regenerated from future biometric measurements of the same user.

At step (410), if asymmetric algorithm-based generation is selected, the method (400) includes generating keys using asymmetric cryptographic algorithms. The processor (202) executes key generation algorithms including RSA key generation by generating large prime numbers through probabilistic primality testing and computing modular arithmetic operations, or elliptic curve key generation by selecting random private key values and computing corresponding public key points through elliptic curve point multiplication on specified curves. The algorithm-based generation produces cryptographically secure key pairs without relying on biometric data.

At step (412), the method (400) includes generating the first user's public key and private key. The processor (202) completes key generation operations for the first user, producing a mathematically related key pair where data encrypted with the public key can only be decrypted with the private key.

At step (414), the method (400) includes generating the second user's public key and private key. The processor (202) performs equivalent key generation operations for the second user, ensuring that each user has unique cryptographic key material.

At step (416), the method (400) includes storing the first user's private key on the first user device. The first user's private key is stored at the first user device. The processor on the first user device (106-1) writes the private key to secure storage areas on the device, including secure enclaves, trusted execution environments, or hardware security modules providing protection against extraction. The private key never leaves the user device and is not transmitted to the server or any external entity, maintaining user control over the key material.

At step (418), the method (400) includes storing the second user's private key on the second user device. The second user's private key is stored at the second user device. The processor on the second user device (106-2) performs equivalent storage operations as step (416) for the second user's private key, ensuring that each user maintains exclusive control over their private key on their respective devices.

At step (420), the method (400) includes transmitting public keys to the server for storage. The processor (202) receives the public keys generated for both users, which unlike private keys can be safely transmitted across networks and stored on servers without compromising security. The processor (202) executes the storage module (218) to store the first user's public key and second user's public key on the server (108), making the public keys available for retrieval when other users need to encrypt identity packets.

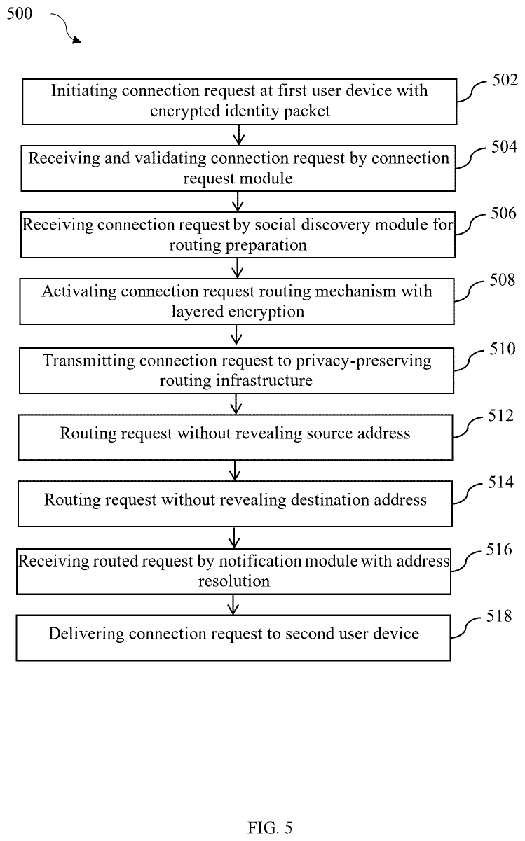

Referring now to FIG. 5, a flowchart of a method (500) illustrating the connection request routing mechanism for privacy-preserving social discovery is shown, in accordance with an embodiment of the present invention. The method (500) describes the systematic steps for routing connection requests from the first user device to the second user device without revealing source or destination addresses to intermediate routing infrastructure.

At step (502), the method (500) includes initiating a connection request at the first user device (106-1). The first user interacts with a user interface on the first user device (106-1) by entering the second user's communication address, and activating a request transmission function. The first user device (106-1) prepares connection request data including the communication address hash of the second user and the encrypted first user identity packet.

At step (504), the method (500) includes transmitting the connection request from the first user device to the system. The processor on the first user device (106-1) transmits the connection request data to the system (102) through the network (104), initiating the connection establishment process.

At step (506), the method (500) includes receiving the connection request by the social discovery module (228) for routing preparation. The processor (202) executes the social discovery module (228) implementing privacy-preserving connection discovery protocols. The social discovery module (228) encapsulates the connection request in routing protocols, prepares routing instructions, and initiates transmission. In an exemplary embodiment, the social discovery module (228) may prepare the connection request for routing through distributed hash table networks (110) implementing onion routing protocols where the connection request is wrapped in multiple layers of encryption. However, any other type of routing mechanism, anonymization network, or privacy-preserving protocol may be used without departing from the scope of the invention.

At step (508), the method (500) includes activating the connection request routing mechanism. The processor (202) executes algorithmic procedures within the social discovery module (228) for executing privacy-preserving routing operations. The routing mechanism selects routing paths that balance latency considerations with privacy protections, constructs layered encryption where each routing layer may be encrypted with cryptographic keys of corresponding intermediate nodes, and injects the prepared connection request into routing infrastructure. The routing mechanism applies cryptographic operations to ensure that source address information identifying the first user device (106-1) and destination address information identifying the second user device (106-2) are not exposed to intermediate routing nodes.

At step (510), the method (500) includes transmitting the connection request to routing infrastructure. The processor (202) sends the encrypted and layered connection request into privacy-preserving routing infrastructure. In an exemplary embodiment, the routing infrastructure may comprise distributed hash table networks (110) comprising multiple independent nodes operated by different entities. However, any other type of routing infrastructure, anonymization network, or distributed communication architecture may be used without departing from the scope of the invention.

At step (512), the method (500) includes routing the request without revealing the source address. The processor executing on intermediate nodes within the routing infrastructure performs routing operations where each node receives an encrypted request, processes routing information to determine the next hop, forwards the request to the next hop, and has no knowledge of the original source address or the ultimate destination address. The routing process ensures that the first user device address remains hidden from all intermediate nodes, protecting the first user's privacy.

At step (514), the method (500) includes routing the request without revealing the destination address. The processor on intermediate nodes ensures that only the final delivery node or the notification module (222) knows the destination address of the second user device (106-2). Intermediate nodes receive and forward encrypted requests without being able to determine the ultimate recipient.

At step (516), the method (500) includes delivering the connection request to the notification module. The routing infrastructure completes delivery of the connection request to the notification module (222) within the system (102) or directly to the second user device (106-2) depending on system architecture.

At step (518), the method (500) includes the notification module transmitting the request to the second user device. The processor (202) executes the notification module (222) to deliver the connection request bundled with the encrypted first user identity packet to the second user device (106-2) through the network (104). The entire routing process accomplishes privacy-preserving connection request delivery where neither the first user device address nor the second user device address is exposed to intermediate routing infrastructure.

The connection request routing method illustrated in FIG. 5 provides technical advantages over centralized routing approaches by eliminating single points of failure and preventing traffic analysis attacks where observers monitoring network communications could infer social relationships.

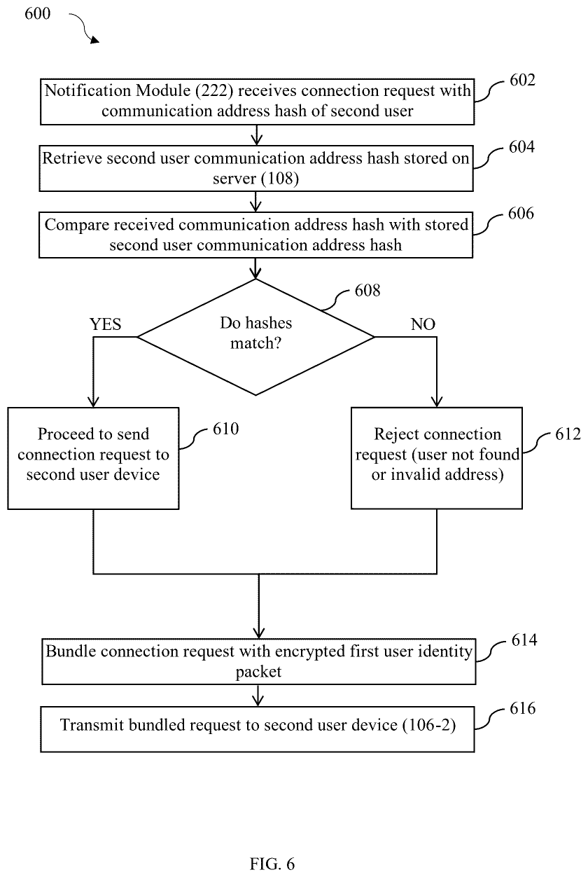

Referring now to FIG. 6, a flowchart of a method (600) illustrating the address hash verification and notification process is shown, in accordance with an embodiment of the present invention. The method (600) describes the systematic steps performed by the notification module (222) to verify that connection request targets exist in the system before attempting delivery.

At step (602), the notification module (222) receives a connection request with the communication address hash of the second user. The processor (202) executes instructions corresponding to the notification module (222) upon receiving a connection request that has been processed by the connection request module (220). The connection request data structure contains the communication address hash of the second user serving as the target identifier and the encrypted first user identity packet.

At step (604), the notification module (222) retrieves the second user communication address hash stored on the server (108). The processor (202) executes a database query operation through the storage module (218) to retrieve user registration data. The query uses the communication address hash from the connection request as the search key to locate matching records in the server storage.

At step (606), the notification module (222) compares the received communication address hash with the stored second user communication address hash. The processor (202) performs a comparison operation between two hash values represented as fixed-length binary strings or hexadecimal values, executing byte-by-byte or bit-by-bit comparison determining whether the two hash values are identical.

At step (608), the notification module (222) determines whether the hashes match. The processor (202) evaluates the comparison result from step (606). If the hashes match, it confirms that the second user is registered in the system and the connection request can be delivered. If the hashes do not match, it indicates that the target user does not exist or the provided communication address is incorrect.

At step (610), executed when hashes match, the notification module (222) confirms the target user exists. The processor (202) determines that the communication address hash from the connection request corresponds to a registered user account. The processor (202) prepares the connection request for transmission by formatting it according to the delivery protocol.

At step (612), executed when hashes do not match, the notification module (222) rejects the connection request and provides feedback. The processor (202) determines that the communication address hash from the connection request does not correspond to any registered user in the system. The processor (202) constructs an error response message indicating that the target user was not found or that the provided communication address is invalid, transmitting the error response back to the first user device (106-1).

At step (614), the notification module (222) bundles the connection request with the encrypted first user identity packet. The processor (202) constructs the final delivery data structure combining the encrypted first user identity packet containing the first user's personally identifiable information encrypted with the second user's public key, connection request metadata, and potentially an anonymized request identifier.

At step (616), the notification module (222) transmits the bundled request to the second user device (106-2). The processor (202) executes network transmission operations sending the bundled connection request data across the network (104) to the second user device, utilizing various delivery mechanisms including push notification protocols for real-time delivery.

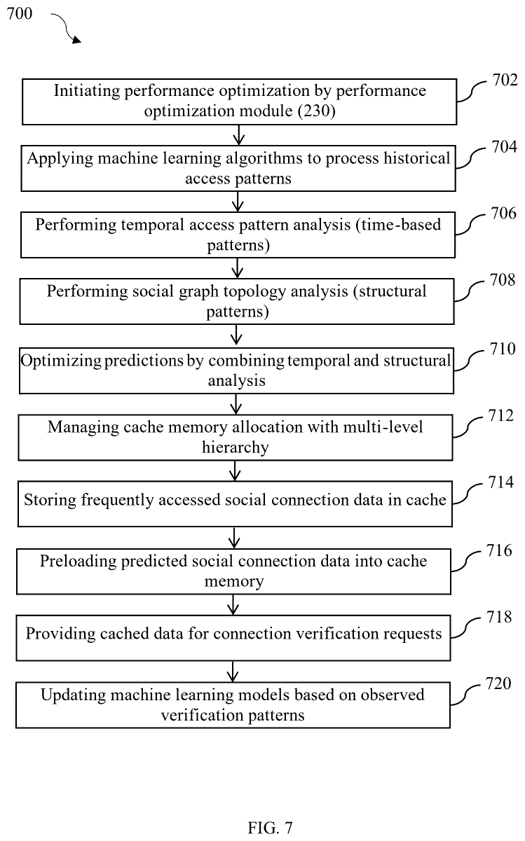

Referring now to FIG. 7, a flowchart of a method (700) illustrating the performance optimization process employing machine learning algorithms for predictive caching is shown, in accordance with an embodiment of the present invention. The method (700) describes the systematic steps for analyzing access patterns, predicting future verification requests, and preloading social connection data including zero-knowledge social connection hashes and associated random numbers into cache memory to reduce verification latency.

At step (702), the method (700) includes initiating performance optimization by the Performance Optimization Module (230). The processor (202) executes instructions corresponding to the Performance Optimization Module (230) to begin intelligent caching operations. The performance optimization module (230) continuously monitors system operation to collect training data for machine learning models, prepares to analyze historical connection verification patterns, and initializes cache memory management structures. The performance optimization module (230) coordinates the overall optimization workflow including data collection, analysis, prediction, and preloading operations.

At step (704), the method (700) includes applying machine learning algorithms to process historical access pattern data. The processor (202) executes machine learning algorithms to analyze historical verification request patterns. The processor (202) retrieves historical data recording which zero-knowledge social connection hashes have been verified, when verifications occurred, which users performed verifications, and contextual information about verification sessions. The machine learning algorithms extract features relevant to prediction including temporal features such as time of day and day of week, user behavioral features such as connection verification frequency and recency, and graph structural features such as connection clustering patterns and community membership. The processor trains prediction models using supervised or unsupervised learning techniques, fitting model parameters to historical data to minimize prediction error. In some embodiments, the machine learning algorithms implement collaborative filtering algorithms that identify similar users based on their verification patterns and predict that a user will verify connections similar to those verified by other similar users, using matrix factorization techniques such as singular value decomposition or alternating least squares. In other embodiments, the machine learning algorithms may implement recurrent neural networks or long short-term memory networks for sequence prediction, processing sequences of past verification events to predict future verifications and capturing temporal dependencies.

At step (706), the method (700) includes performing temporal access pattern analysis. The processor (202) applies machine learning models specifically focused on temporal patterns in verification behavior. The temporal analysis identifies time-of-day patterns where certain connections are more likely to be verified during specific hours, recognizes day-of-week patterns where verification behavior differs between weekdays and weekends, detects seasonal patterns in verification activity, and identifies session-based patterns where verification of one connection predicts imminent verification of related connections. The processor (202) constructs temporal feature vectors encoding these patterns, applies time series analysis techniques, and generates temporal predictions indicating when specific connections are likely to be verified. The temporal analysis enables the performance optimization module to preload connection data at optimal times immediately before predicted verification requests.

At step (708), the method (700) includes performing social graph topology analysis. The processor (202) applies machine learning models that analyze the structure of the social graph to predict verification patterns. The topology analysis identifies community structures within the social graph where users cluster into tightly connected groups, recognizes connection bridging patterns where certain connections link different communities, detects centrality patterns where highly central users have different verification patterns than peripheral users, and analyzes clustering coefficients indicating how users' connections are interconnected. The processor (202) applies graph-based algorithms including PageRank, community detection algorithms, and graph neural networks to extract structural features. The topology analysis predicts that verification of connections within a community cluster are correlated, enabling preloading of multiple related connections based on observed verification of one connection in the cluster.

At step (710), the method (700) includes generating predictions for future verification requests. The processor (202) combines outputs from temporal analysis and topology analysis to produce comprehensive predictions. The processor (202) applies ensemble methods combining multiple prediction models, weights predictions based on model confidence scores, and generates ranked lists of zero-knowledge social connection hashes predicted for verification within specific time windows. The predictions specify which connections are likely to be verified, when verifications are predicted to occur, and confidence scores indicating prediction reliability. In some embodiments, the processor (202) implements online learning where prediction models are continuously updated as new verification events occur, enabling adaptation to evolving user behavior patterns without requiring offline retraining phases.

At step (712), the method (700) includes retrieving zero-knowledge social connection hashes and associated random numbers from the server for predicted connections. The processor (202) executes data retrieval operations for connections predicted in step (710). For each predicted connection, the processor (202) retrieves both the zero-knowledge social connection hash (ZKSC1) and its associated random number (R1) from the server (108) storage through the storage module (218). The retrieval operations query the server using connection identifiers or user pair identifiers as keys, retrieving the complete data set required for verification including ZKSC1 values and their corresponding R1 values. The processor (202) performs these retrieval operations asynchronously without blocking foreground request processing, executing queries during periods of low system load to minimize performance impact on active user operations.

At step (714), the method (700) includes evaluating cache capacity and implementing cache management policies. The processor (202) monitors available cache memory capacity, tracks current cache utilization, and determines how many additional zero-knowledge social connection hashes and random numbers can be loaded into cache. The processor (202) implements cache eviction policies to free space when cache capacity is reached, selecting items for eviction based on criteria including least recently used (LRU) policies that evict connections not verified recently, least frequently used (LFU) policies that evict connections verified infrequently, or prediction-based policies that evict connections with lowest predicted verification probability. In some embodiments, the processor (202) implements adaptive cache sizing that dynamically adjusts cache capacity allocation based on observed cache hit rates and available system memory, increasing cache size when hit rates are high and memory is available, or decreasing cache size when system memory pressure requires freeing resources.

At step (716), the method (700) includes preloading predicted zero-knowledge social connection hashes and random numbers into cache memory. The processor (202) receives prediction outputs from step (710) identifying specific zero-knowledge social connection hashes and their associated random numbers predicted for future verification, determines optimal preloading timing balancing predictive lead time against prediction accuracy degradation, executes asynchronous data retrieval operations that fetch predicted ZKSC1 and R1 pairs from server (108) storage without blocking foreground verification requests, and inserts retrieved data into cache memory using cache management policies. In some embodiments, the processor (202) implements adaptive preloading rates that adjust the number of connections preloaded per time unit based on available system resources, increasing preloading aggressiveness when processor (202) and memory resources are underutilized, and reducing preloading when system load is high to avoid interfering with foreground request processing.

At step (718), the method (700) includes providing cached data for connection verification requests. The processor (202) services connection verification requests from the verification module (226) by retrieving zero-knowledge social connection hashes and associated random numbers from cache memory when available, avoiding the need to access server storage. When a verification request is received, the processor checks cache memory for the required ZKSC1 and R1 pair, retrieves both values with sub-microsecond latency if present in cache, and returns them to the verification module (226) for generating ZKSC2 and performing comparison with ZKSC1. If the required data is not present in cache (cache miss), the processor retrieves both ZKSC1 and R1 from server storage and may add them to cache for future accesses. The processor tracks cache hit rates and uses this feedback to improve prediction models and caching strategies.

At step (720), the method (700) includes updating machine learning models based on observed verification patterns. The processor (202) implements continuous learning procedures that incorporate new verification data into the machine learning models. As users perform connection verifications during normal system operation, the processor (202) records these events as new training data, periodically retrains or incrementally updates prediction models to incorporate the latest usage patterns, evaluates model performance by comparing predictions with actual verification events, and adapts caching strategies based on observed effectiveness. This feedback loop enables the performance optimization to continuously improve over time, adapting to evolving user behavior patterns and seasonal variations without requiring manual intervention.

The performance optimization method illustrated in FIG. 7 provides substantial technical advantages in connection verification latency reduction. Without predictive caching, connection verification requires retrieving zero-knowledge social connection hashes and associated random numbers from server (108) storage with access latencies typically ranging from approximately 10 milliseconds to approximately 100 milliseconds. With predictive caching effectively preloading both ZKSC1 and R1 values before verification requests occur, verification operations retrieve data from cache memory with access latencies under approximately 1 microsecond, representing latency reductions of approximately four to five orders of magnitude. In some embodiments, effective prediction algorithms achieve cache hit rates exceeding 80% or 90%, meaning that 80-90% of verification requests find required data already present in cache. The machine learning-based approach adapts to individual user behavior patterns and temporal variations, providing personalized optimization that static caching policies cannot achieve.

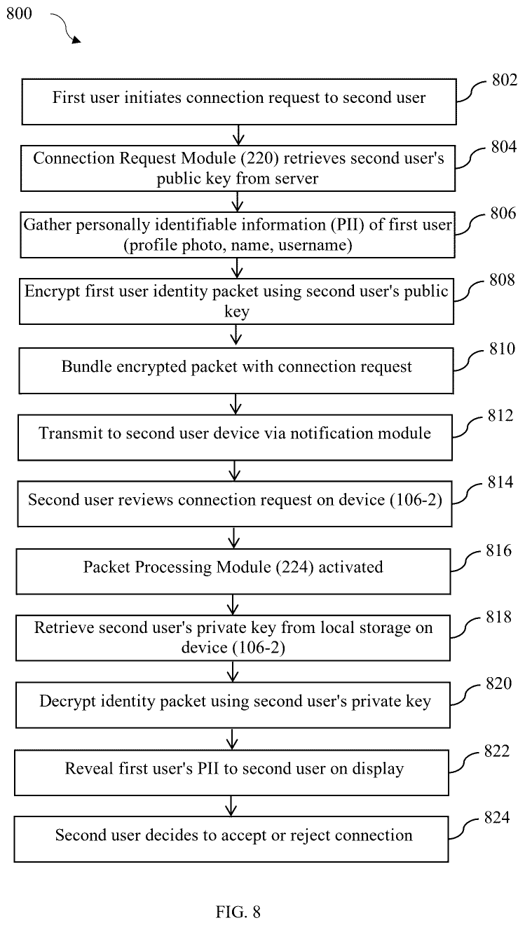

Referring now to FIG. 8, a sequence diagram showing the identity packet encryption, transmission, and decryption flow for session-revealed identity disclosure is illustrated, in accordance with an embodiment of the present invention. FIG. 8 depicts the temporal sequence of operations and component interactions involved in encrypting the first user's personally identifiable information, transmitting it as part of a connection request, and decrypting it on the second user device to reveal identity information only when the second user chooses to review the request.

At step (802), the first user initiates a connection request to the second user. The first user interacts with user interface components on the first user device (106-1), entering the second user's communication address through input mechanisms such as keyboard entry, voice input, or selection from suggested contacts. The first user may optionally compose a message to accompany the connection request explaining why they wish to connect. The first user device (106-1) captures this input and prepares to initiate the connection request process. The user interface validates the format of the entered communication address, ensuring it conforms to expected patterns for email addresses, phone numbers, or proxy addresses depending on address type. In some embodiments, the user interface implements auto-completion features suggesting communication addresses based on partially entered text, reducing input errors and improving user experience. The first user confirms their intent to send the connection request by activating a submission control such as a “Send Request” button.

At step (804), the connection request module (220) retrieves the second user's public key from the server. The processor (202) executes the connection request module (220) which first hashes the entered communication address using the hash generation module (214) to produce the communication address hash of the second user. The connection request module (220) then queries the server (108) through the storage module (218) to retrieve the public key associated with the second user identified by the communication address hash. The processor (202) constructs a database query specifying the communication address hash as the search key, transmits the query to the server (108), and receives the second user's public key in the query response. In some embodiments, the connection request module (220) implements caching of recently retrieved public keys, storing them temporarily in memory (204) to avoid repeated database queries for connection requests targeting the same user within short time periods, reducing public key retrieval latency and database load. The public key retrieval is essential for the subsequent encryption step because the identity packet must be encrypted with the specific public key corresponding to the target user to ensure only that user can decrypt it.

At step (806), the connection request module (220) gathers the personally identifiable information (PII) of the first user. The processor (202) retrieves the first user's profile data from local storage on the first user device (106-1) or from user account data cached in memory (204). The personally identifiable information comprises a profile photo, a name, a username, and any other personally identifying information that enables recipient identification. The profile photo is retrieved as binary image data, typically in formats such as JPEG or PNG with resolution optimized for display on receiving devices. The name and username are retrieved as text strings. Additional personally identifying information may include biographical text, location information, or other profile attributes the first user has chosen to include in their profile. The processor (202) structures this information into a data packet format organizing the components for encryption. In some embodiments, the data packet implements structured formats such as JSON or Protocol Buffers providing efficient serialization and deserialization, representing the identity packet as a structured object with fields for each component of personally identifiable information. The packet may include metadata such as packet version numbers enabling future protocol evolution and timestamps indicating when the packet was created.

At step (808), the connection request module (220) encrypts the first user identity packet using the second user's public key. The processor (202) applies asymmetric encryption algorithms to the identity packet data using the second user's public key retrieved in step (804). The encryption process transforms the plaintext identity packet into ciphertext that is computationally infeasible to decrypt without the corresponding private key. In some embodiments, the connection request module (220) implements hybrid encryption schemes where the identity packet is first encrypted using symmetric encryption with a randomly generated session key, and the session key itself is encrypted using the second user's public key. For example, the processor (202) may generate a random 256-bit AES key, encrypt the identity packet using AES-256 in GCM mode providing both confidentiality and authenticity, then encrypt the AES key using RSA-OAEP with the second user's public key, producing an encrypted packet containing both the symmetrically encrypted data and the asymmetrically encrypted session key. This hybrid approach provides computational efficiency for potentially large identity packets while maintaining the security properties of asymmetric cryptography. In other embodiments, the connection request module (220) may apply direct asymmetric encryption using Elliptic Curve Integrated Encryption Scheme (ECIES) for smaller identity packets, implementing the encryption through elliptic curve operations that are more efficient than RSA for equivalent security levels. The resulting encrypted first user identity packet is computationally secure, meaning that even if intercepted during transmission, the packet contents cannot be decrypted by attackers lacking the second user's private key.

At step (810), the connection request module (220) bundles the encrypted packet with the connection request. The processor (202) constructs the complete connection request data structure combining the encrypted first user identity packet with the communication address hash of the second user identifying the target recipient. The bundled structure may include additional fields such as a connection request identifier enabling tracking through the system, a timestamp indicating when the request was created, and cryptographic signatures authenticating the request origin. The processor (202) serializes the bundled structure into a format suitable for network transmission, applying encoding schemes such as base64 for binary data if required by transmission protocols. The bundled connection request maintains the association between the encrypted identity packet and the target user identifier throughout subsequent processing steps.

At step (812), the notification module (222) transmits the connection request to the second user device. The processor (202) executes the notification module (222) which performs address hash verification as described in FIG. 6 to confirm the target user exists, retrieves network addressing information for the second user device (106-2), and initiates network transmission. The transmission traverses the network (104) using transport protocols such as TCP for reliable delivery or UDP for lower-latency delivery depending on system design choices. In some embodiments, the transmission implements push notification delivery mechanisms where the notification module (222) interfaces with platform-specific push notification services, transmitting the bundled connection request through Apple Push Notification service for iOS devices or Firebase Cloud Messaging for Android devices, enabling the connection request to be delivered to the second user device even when the application is not actively running and waking the application upon receipt. The transmission may apply transport-layer encryption such as TLS to protect against network eavesdropping during transit, providing defense-in-depth even though the identity packet itself is already encrypted. The second user device (106-2) receives the transmitted connection request and stores it in local storage for subsequent user review.

At step (814), the second user reviews the connection request on the device (106-2). The second user device (106-2) presents a notification to the second user alerting them that a new connection request has been received. The notification may include basic information such as the number of pending requests but does not reveal the requesting user's identity until the second user actively chooses to review the request, maintaining privacy control. The second user interacts with the user interface by selecting the connection request notification, which causes the device to display a connection request review screen. At this point, the encrypted identity packet has been received but not yet decrypted, so the second user does not yet know who is requesting to connect. The user interface may display a message indicating “Encrypted connection request-tap to reveal” or similar language preparing the second user that identity revelation will occur. The second user activates a control to decrypt and view the requesting user's identity.

At step (816), the packet processing module (224) is activated. The activation occurs when the second user chooses to review the connection request and reveal the requesting user's identity. The packet processing module (224) may be implemented as client-side code executing on the second user device (106-2) rather than server-side code, ensuring that decryption operations occur locally on the user's device. The processor on the second user device retrieves the encrypted first user identity packet from local storage where the received connection request was stored. The packet processing module (224) prepares to perform decryption operations requiring access to the second user's private key.

At step (818), the packet processing module (224) retrieves the second user's private key from local storage on device (106-2). The processor on the second user device accesses secure storage areas where the second user's private key is stored. The private key is stored in protected storage regions such as Android Keystore, iOS Keychain, or hardware security modules providing protection against extraction. In some embodiments, the private key retrieval requires additional authentication from the second user such as biometric authentication using fingerprint or face recognition, PIN entry, or device unlock credentials, providing additional security ensuring that even if a device is lost or stolen, the private key cannot be accessed without authentication. The processor (202) retrieves the private key into secure memory regions where it will be used for decryption operations and then cleared to prevent memory dumping attacks.

At step (820), the packet processing module (224) decrypts the identity packet using the second user's private key. The processor on the second user device applies asymmetric decryption algorithms corresponding to the encryption method used in step (808). If hybrid encryption was employed, the processor (202) first decrypts the symmetric session key by applying RSA-OAEP decryption or ECIES decryption using the second user's private key, recovering the AES session key, then decrypts the identity packet contents using AES decryption with the recovered session key. If direct asymmetric encryption was employed, the processor (202) applies RSA or ECC decryption directly to the identity packet. The decryption process reconstructs the plaintext identity packet containing the first user's personally identifiable information. The processor (202) validates the decrypted data integrity, verifying that decryption succeeded correctly and that the packet has not been corrupted or tampered with during transmission. In some embodiments, the encryption includes authentication tags or digital signatures that are verified during decryption, providing cryptographic assurance that the identity packet was created by the claimed sender and has not been modified.

At step (822), the packet processing module (224) reveals the first user's PII to the second user on the display. The processor on the second user device (106-2) renders the decrypted personally identifiable information on the device display. The rendering process formats the profile photo for display at appropriate resolution, displays the name and username in text fields, and presents any additional biographical information included in the identity packet. The user interface provides the second user with controls to accept or reject the connection request based on the revealed identity information. The display presents the information in a user-friendly format enabling the second user to make an informed decision about whether to accept the connection.

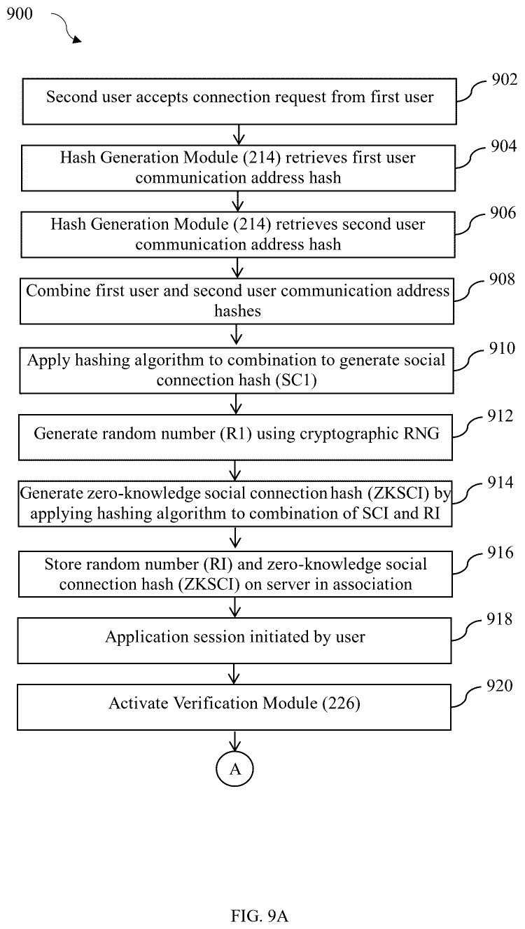

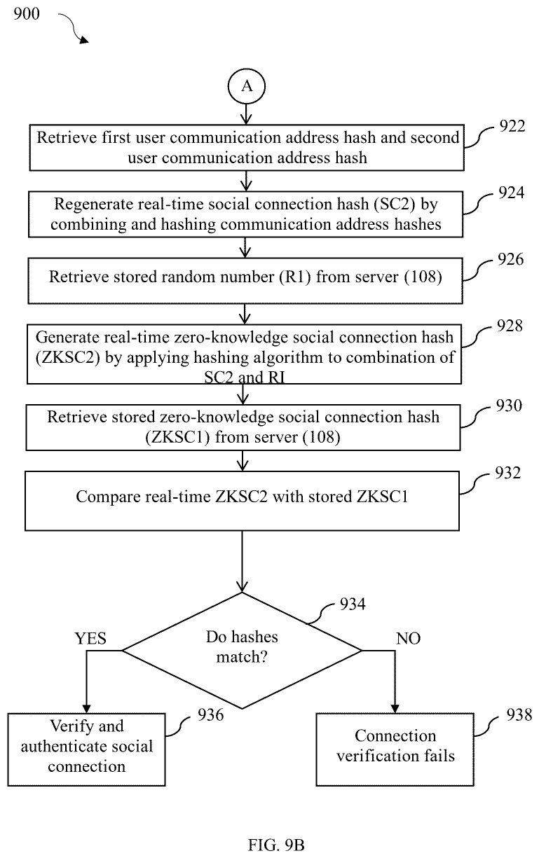

At step (824), the second user decides whether to accept or reject the connection request. If the second user wishes to establish a connection with the first user based on the revealed identity information, they activate an “Accept” control on the user interface. If the second user does not wish to connect, they may activate a “Reject” or “Ignore” control. The second user device captures this input and transmits the decision to the system (102) through the network (104). If the connection is accepted, the system proceeds to generate the zero-knowledge social connection hash as described in FIGS. 9A and 9B, creating the verified connection between the two users. If the connection is rejected, the system discards the connection request and no connection is established. In some embodiments, the system provides feedback to the first user indicating that their connection request was reviewed and the outcome, enabling the first user to know whether their request was accepted or declined. In other embodiments, the system may implement privacy-preserving rejection where the first user is not explicitly notified of rejection to prevent social pressure or retaliation concerns, instead simply indicating that the request is pending indefinitely.

The identity packet encryption and decryption flow illustrated in FIG. 8 provides crucial privacy protections for the zero-knowledge social graph management system. By encrypting identity packets with recipient-specific public keys, the system ensures that identity information is revealed only to intended recipients and only when recipients explicitly choose to view it. The asymmetric encryption prevents system administrators, network observers, and intermediate routing nodes from accessing identity information even though they handle encrypted packets during transmission. The session-revealed identity approach provides users with control over identity disclosure timing, allowing recipients to receive connection requests without immediately learning requester identities, and choosing when to decrypt and review identity information. This architecture supports use cases where users wish to limit their exposure to connection requests, reviewing them selectively rather than having identity information automatically revealed for all requests. The cryptographic security of modern asymmetric encryption algorithms ensures that encrypted identity packets remain secure for many decades even with anticipated computational advances, providing long-term privacy protection. In some embodiments, the encryption employs post-quantum cryptographic algorithms resistant to attacks by quantum computers, future-proofing the system against potential quantum computing advances that could compromise classical asymmetric encryption schemes like RSA and ECC.

Referring now to FIGS. 9A and 9B, a flowchart of a method (900) illustrating the zero-knowledge social connection hash generation and verification process with random number integration for enhanced privacy protection is shown, in accordance with an embodiment of the present invention. The method (900) describes the detailed steps for creating cryptographic proofs of social connections using random number-enhanced zero-knowledge hashes when users accept connection requests, and subsequently verifying those connections during application sessions without exposing user identities or enabling reverse-engineering attacks.

At step (902), the second user accepts the connection request from the first user. The second user interacts with user interface components on the second user device (106-2) after reviewing the decrypted identity information, activating an “Accept” control indicating their consent to establish a social connection with the first user. The second user device captures this acceptance input and transmits an acceptance message to the system (102) through the network (104). The acceptance message includes identifiers for both the first user and second user, typically in the form of their communication address hashes, and potentially includes a timestamp and acceptance confirmation token. The processor (202) receives the acceptance message through the I/O Interface (206) and prepares to generate the zero-knowledge social connection hash that will cryptographically represent the verified connection.

At step (904), the hash generation module (214) retrieves the first user communication address hash. The processor (202) executes the hash generation module (214) which queries the server (108) storage through the storage module (218) to retrieve the first user communication address hash. The retrieval operation uses the first user identifier from the acceptance message as the query key, locating the stored hash value generated during the first user's registration process. The processor (202) loads the first user communication address hash into working memory for subsequent processing. The first user communication address hash is a fixed-length cryptographic hash value representing the first user's communication address without revealing the actual address in plaintext form.

At step (906), the hash generation module (214) retrieves the second user communication address hash. The processor (202) executes similar retrieval operations as step (904) but for the second user, querying the server (108) storage to retrieve the second user communication address hash using the second user identifier as the query key. The processor (202) loads the second user communication address hash into working memory alongside the first user communication address hash. Both communication address hashes are now available for the social connection hash generation process.

At step (908), the hash generation module (214) combines the first user communication address hash and the second user communication address hash. The processor (202) applies a deterministic combination operation to produce a combined input for hash generation. The combination method must be commutative or order-normalized to ensure that the same pair of users always produces the same combined value regardless of which user initiated the connection or the order in which hashes are processed. In some embodiments, the processor (202) implements lexicographic ordering where the two communication address hashes are sorted alphabetically or numerically and then concatenated in sorted order, producing a combined value like Hash1∥Hash2 where Hash1≤Hash2 lexicographically. In other embodiments, the processor (202) may apply XOR operations combining the two hashes through bitwise exclusive-or, producing a commutative combination that is order-independent by the mathematical properties of XOR. The combined value serves as input for generating the social connection hash (SC1).

At step (910), the hash generation module (214) applies a hashing algorithm to the combination to generate the social connection hash (SC1). The processor (202) executes a cryptographic hash function on the combined input produced in step (908), computing a fixed-length hash value that represents the social connection hash (SC1). The hashing algorithm applies the same cryptographic hash function used for generating communication address hashes, ensuring consistency across the system. In some embodiments, the hashing algorithm implements SHA-256, processing the combined input through SHA-256's compression function involving 64 rounds of bitwise operations, additions, and logical functions, producing a 256-bit hash output. In other embodiments, the hashing algorithm may implement SHA-3, BLAKE2, or other collision-resistant cryptographic hash functions. The hash computation executes deterministically, meaning that identical inputs always produce identical outputs, ensuring that the same social connection between two users always generates the same social connection hash (SC1) regardless of when the hash is computed or which system component performs the computation. This intermediate social connection hash (SC1) will be further combined with a random number to produce the final zero-knowledge social connection hash.

At step (912), the hash generation module (214) generates a random number (R1) for the social connection. The processor (202) executes a random number generation algorithm to produce a cryptographically secure random number (R1) specific to this social connection between the first user and the second user. The random number (R1) is generated using cryptographically secure random number generation algorithms providing sufficient entropy to prevent prediction or brute-force attacks. In some embodiments, the processor (202) implements hardware random number generators utilizing physical entropy sources such as thermal noise, quantum phenomena, or timing jitter to generate true random numbers with high entropy quality. In other embodiments, the processor (202) may implement cryptographically secure pseudorandom number generators (CSPRNGs) such as /ev/urandom on Linux systems, CryptGenRandom on Windows systems, or algorithm-based generators like HMAC-DRBG or CTR-DRBG specified in NIST SP 800-90A, seeded with sufficient entropy from system sources. The random number (R1) typically has length matching the hash output length, for example 256 bits when using SHA-256, providing sufficient randomness to prevent attackers from reverse-engineering social connections by hashing known communication address combinations. The random number serves as a cryptographic salt that ensures attackers cannot predict or compute valid zero-knowledge social connection hashes even when communication addresses are publicly available.

At step (914), the hash generation module (214) generates the zero-knowledge social connection hash (ZKSC1) by applying the hashing algorithm to a combination of the social connection hash (SC1) and the random number (R1). The processor (202) combines the social connection hash (SC1) generated in step (910) with the random number (R1) generated in step (912), producing a combined input for the final hash generation. The combination typically implements concatenation where SC1 and R1 are concatenated to form SC1∥R1, or alternatively may apply XOR or other combination operations. The processor (202) applies the cryptographic hash function to this combination, executing the same hash algorithm used in step (910) to ensure consistency. The resulting zero-knowledge social connection hash (ZKSC1) provides cryptographic proof of connection existence without enabling reverse-engineering of the underlying communication addresses. The ZKSC1 value depends on both the communication address hash (SC1) and the secret random number (R1), ensuring that attackers cannot generate valid ZKSC values by hashing known communication address combinations because they lack knowledge of R1. This random number integration transforms a potentially vulnerable hash (SC1 alone) into a true zero-knowledge proof that prevents discovery of social connections even when communication addresses are publicly known.

At step (916), the storage module (218) stores the random number (R1) and the zero-knowledge social connection hash (ZKSC1) on the server (108). The processor (202) executes the storage module (218) to persist both values, storing the random number (R1) in association with the zero-knowledge social connection hash (ZKSC1) to enable subsequent retrieval during verification operations. The association between R1 and ZKSC1 is maintained through database relationships, composite keys, or data structure linkages ensuring that the correct random number can be retrieved when verifying a specific connection. In some embodiments, the storage implements relational database schemas where a connections table includes columns for user_pair_identifier, zksc1_hash, and random_number_r1, with indexes enabling efficient lookup by user pair. In other embodiments, the storage may implement key-value stores where ZKSC1 serves as the key and R1 is stored as the associated value, or alternatively where a connection identifier serves as the key and a structured value containing both ZKSC1 and R1 is stored. The storage module (218) ensures data persistence across system restarts, implements backup and recovery mechanisms to prevent data loss, and may implement replication across multiple storage nodes for high availability. The stored ZKSC1 and R1 values enable the verification process described in subsequent steps.

At step (918), users initiate an application session. After connection establishment has completed, at some future time the first user or second user launches the application on their user device, establishing a session that requires verification of their social connection before granting access to connection-dependent features. The user authenticates to the application using authentication mechanisms such as password entry, biometric authentication, or device-based authentication. Once authenticated, the application session begins and the user can access various application features. Some application features may require verification of specific social connections before granting access, triggering the verification process described in subsequent steps.

At step (920), the verification module (226) is activated. The activation occurs when application logic determines that a social connection must be verified before proceeding with a requested operation. For example, if the first user attempts to send a message to the second user, view the second user's profile information, or perform any action requiring a verified connection, the verification module (226) is invoked to confirm that the connection exists. The processor (202) executes instructions corresponding to the verification module (226), receiving as input the identifiers of the two users whose connection must be verified, typically represented as their communication address hashes.

At step (922), the verification module (226) retrieves the first user communication address hash and the second user communication address hash. The processor (202) executes similar retrieval operations as steps (904) and (906), querying server storage to obtain both users' communication address hashes. If the hashes are already cached in memory from previous verification operations during the same session, the processor may retrieve them from cache, avoiding database queries and reducing verification latency. The processor loads both communication address hashes (236) into working memory for hash generation.

At step (924), the verification module (226) regenerates the real-time social connection hash (SC2). The processor (202) executes the hash generation module (214) applying exactly the same operations described in steps (908) and (910), combining the two communication address hashes (236) using the same deterministic combination method and applying the same hashing algorithm. The resulting real-time social connection hash (SC2) is computed on-demand during the verification operation rather than being retrieved from storage. This real-time generation is essential for the verification approach because it proves that the verifying party knows both users' communication address hashes, providing evidence that verification is being performed by authorized system components rather than external attackers. The real-time generation executes quickly, typically completing in under approximately 1 millisecond including hash retrieval and computation on modern processors.

At step (926), the verification module (226) retrieves the stored random number (R1) from the server (108). The processor (202) queries the server storage through the storage module (218) to retrieve the random number associated with the connection between the first user and second user. The query uses connection identifiers or user pair identifiers as lookup keys, searching for the R1 value stored during connection establishment in step (916). The processor (202) receives the query results containing the stored random number (R1) if a connection exists. If the query returns no results, it indicates that no verified connection exists between the two users. The retrieval of R1 is essential for generating the real-time zero-knowledge social connection hash that will be compared with the stored ZKSC1.

At step (928), the verification module (226) generates the real-time zero-knowledge social connection hash (ZKSC2) by applying the hashing algorithm to a combination of the real-time social connection hash (SC2) and the retrieved random number (R1). The processor (202) combines SC2 generated in step (924) with R1 retrieved in step (926), using the same combination method employed in step (914) to ensure consistency. The processor (202) applies the cryptographic hash function to this combination, producing the real-time zero-knowledge social connection hash (ZKSC2). This ZKSC2 value represents what the zero-knowledge social connection hash should be if the connection is valid, based on the current communication address hashes and the stored random number. The ZKSC2 generation mirrors the ZKSC1 generation performed during connection establishment, enabling cryptographic verification through hash comparison.

At step (930), the verification module (226) retrieves the stored zero-knowledge social connection hash (ZKSC1) from the server (108). The processor (202) queries server storage through the storage module (218) to obtain the ZKSC1 value that was stored during connection establishment in step (916). The query may be structured as a direct lookup using the real-time hash as a key, or as a search for connection records associated with both users. The processor (202) receives the query results containing the stored zero-knowledge social connection hash (ZKSC1) if a connection exists. This stored ZKSC1 serves as the reference value against which the real-time ZKSC2 will be compared to verify connection validity.

At step (932), the verification module (226) compares the real-time zero-knowledge social connection hash (ZKSC2) with the stored zero-knowledge social connection hash (ZKSC1). The processor (202) performs a comparison operation between the ZKSC2 computed in step (928) and the ZKSC1 retrieved in step (930). The comparison executes through bitwise or byte-by-byte comparison determining whether the hash values are identical. In some embodiments, the comparison implements constant-time comparison algorithms where execution time remains constant regardless of comparison outcome, preventing timing side-channel attacks that could potentially leak information about hash contents through variation in comparison execution time. The comparison produces a boolean result indicating whether the hashes match.

At step (934), the verification module (226) determines whether the hashes match. The processor (202) evaluates the comparison result from step (932). If ZKSC2 matches ZKSC1 exactly, it provides cryptographic assurance that the same pair of users whose connection was established and stored in steps (902-916) are being verified, confirming that a valid connection exists. The match indicates that: (1) both users' communication address hashes used in verification are the same as those used during connection establishment, (2) the correct random number (R1) has been retrieved, and (3) all hash computations have been performed correctly. If ZKSC2 does not match ZKSC1, it indicates either that no connection exists between the users or that one or both users' communication addresses have changed since connection establishment, requiring connection re-establishment.

At step (936), executed when hashes match, the verification module (226) verifies and authenticates the social connection. The processor (202) confirms that a valid, verified connection exists between the first user and second user. The verification result is returned to the requesting application logic, which proceeds to grant access to the requested feature or operation that required connection verification. The application may display information to the user confirming successful verification, or may proceed transparently without explicit notification if verification was expected to succeed. The successful verification enables features such as direct messaging, profile viewing, content sharing, or any other functionality requiring verified connections. The verification completes the connection lifecycle from initial registration through connection establishment to ongoing verification during application usage.

At step (938), executed when hashes do not match, connection verification fails. The processor (202) determines that no verified connection exists between the users. The verification result indicating failure is returned to the requesting application logic, which denies access to the requested feature or operation. The application may display an error message to the user such as “You must be connected to perform this action” or “Connection not found,” prompting the user to send a connection request if they wish to establish a connection. In some embodiments, the application provides streamlined workflows allowing users to immediately send a connection request from the verification failure screen, reducing friction in the connection establishment process. The verification failure may also indicate technical issues such as data corruption or synchronization problems, which may trigger error logging and administrative alerts for system maintenance.

The zero-knowledge social connection hash generation and verification process illustrated in FIGS. 9A and 9B provides enhanced privacy protections through random number integration that prevent reverse-engineering attacks. By generating ZKSC values from combinations of social connection hashes with random numbers, the system prevents attackers from discovering social connections by hashing known communication address combinations. Without the random number integration, an attacker who knows that Alice's communication address is alice@example.com and Bob's communication address is bob@example.com could hash various communication address combinations, compare the results with stored social connection hashes, and discover whether Alice and Bob are connected. The random number (R1) serves as a cryptographic salt that cannot be predicted or accessed by attackers without authorization, ensuring that valid zero-knowledge social connection hashes cannot be generated or recognized without authorized access to the stored random number. This transforms the social connection hash from a deterministic value (SC1) that could be brute-forced or pre-computed into a true zero-knowledge proof that provides cryptographic evidence of connection existence without revealing the underlying communication addresses or enabling discovery of connections through exhaustive search. The verification process maintains these privacy guarantees by requiring retrieval of the secret random number (R1) from server storage, ensuring that only authorized system components performing verification within the security perimeter can access the R1 values necessary to compute valid ZKSC2 hashes for comparison. The method (900) thus achieves the design goal of zero-knowledge social graph management where social connections can be cryptographically verified without exposing user identities or enabling inference of social relationships through analysis of stored connection data.

The present invention provides technical advancement in the field of decentralized social networking systems with cryptographic privacy protections. The disclosed computer-implemented system addresses significant limitations of existing centralized social networking approaches, which typically store complete social graph data in plaintext on centralized servers creating single points of failure vulnerable to breaches, require users to disclose identities during connection discovery processes exposing relationship patterns to network observers and platform administrators, lack mechanisms for proving connection existence without revealing underlying identities to verification parties, and are vulnerable to reverse-engineering attacks where adversaries can discover social connections by hashing known communication address combinations and comparing results with stored connection hashes.

In particular, the present invention provides a zero-knowledge social graph management architecture implementing random number-enhanced cryptographic hash-based connection verification, privacy-preserving connection request routing mechanisms, session-revealed identity disclosure through asymmetric encryption, and machine learning-enhanced performance optimization, which collectively offer substantial improvements in privacy protection, censorship resistance, verification efficiency, and user control over identity disclosure compared to conventional centralized architectures. By implementing the random number-enhanced zero-knowledge hash verification mechanism where social connections are represented as cryptographic hashes combining user communication address hashes with connection-specific random numbers, the disclosed system enables verification of connection existence without storing or exposing plaintext user identities while preventing reverse-engineering attacks, providing cryptographic privacy guarantees that centralized systems and conventional hash-based systems cannot achieve.

The technical contribution lies in the integrated architecture combining zero-knowledge proof mechanisms with random number integration for connection verification, privacy-preserving routing mechanisms for anonymous connection request routing, and asymmetric encryption for recipient-controlled identity revelation, creating a comprehensive privacy-preserving social networking system. Unlike conventional centralized approaches that store complete social graphs in plaintext enabling platform surveillance and creating attractive targets for data breaches, the present invention achieves privacy-preserving social connection management through cryptographic mechanisms that prevent identity exposure even to system administrators and database operators. Unlike conventional hash-based systems that are vulnerable to reverse-engineering attacks where adversaries with knowledge of communication addresses can discover social connections by computing hashes of address combinations, the present invention implements random number integration where each social connection hash incorporates a secret random number stored in association with the connection, preventing attackers from generating valid zero-knowledge social connection hashes even when communication addresses are publicly known. Unlike traditional connection discovery systems that expose connection request patterns to network observers through centralized routing, the present invention implements privacy-preserving routing mechanisms with layered encryption ensuring that no intermediate routing entity can determine both source and destination addresses of connection requests. Unlike conventional systems requiring immediate identity disclosure when connection requests are received, the present invention implements session-revealed identity protocols where recipients control the timing of identity decryption, viewing encrypted requests and choosing when to reveal requester identities.

The foregoing description presents exemplary embodiments for purposes of illustration and enablement. The invention is not limited to the precise forms disclosed. Modifications and variations are possible in light of the above teachings or may be acquired from practice of the invention, and may be made without departing from the scope of the appended claims. The embodiments were selected to explain principles and practical applications, enabling others skilled in the art to utilize the invention in various embodiments and with various modifications as suited to the particular use contemplated. The scope of the invention is defined by the appended claims and their equivalents.

[symbol]

1. A system (102) for zero-knowledge social graph management, with session-revealed identities, the system (102) comprising:
a memory (204); and
a processor (202) coupled to the memory (204), wherein the processor (202) is configured to execute programmed instructions stored in the memory (204) for:
receiving, by a user registration module (212), a first registration request, from a first user of a first user device, wherein the first registration request comprises a first user communication address;
receiving, by the user registration module (212), a second registration request, from a second user of a second user device, wherein the second registration request comprises a second user communication address;
generating, by a hash generation module (214), a first user communication address hash and a second user communication address hash by hashing the first user communication address and the second user communication address respectively;
generating, by a key generation module (216), a first user's public key and a first user's private key corresponding to the first user, and a second user's public key and a second user's private key corresponding to the second user;
storing, by a storage module (218), the first user communication address hash, the second user communication address hash, the first user's public key, and second user's public key on a server (108), thereby registering the first user and the second user;
generating, by a connection request module (220), an encrypted first user identity packet comprised of personally identifiable information of the first user, wherein the encrypted first user identity packet is encrypted using the second user's public key;
receiving, by the hash generation module (214), a communication address of the second user, wherein the communication address of the second user is entered by the first user at the first user device;
hashing, by the hash generation module (214), the communication address of the second user to generate a second user communication address hash;
receiving, by a connection request module (220), a connection request from the first user targeting the second user, wherein the connection request comprises the second user communication address hash and the encrypted first user identity packet;
sending, by a notification module (222), the connection request bundled with the encrypted first user identity packet, to the second user device;
decrypting, by a packet processing module (224), the first user identity packet with the second user's private key when the second user reviews the connection request, and revealing the personally identifiable information of the first user to the second user on the second user device;
generating, by the hash generation module (214), a zero-knowledge social connection hash (ZKSC1) when the second user accepts the connection request from the first user, wherein the zero-knowledge social connection hash (ZKSC1) is generated by:
applying a hashing algorithm to a combination of the first user communication address hash and the second user communication address hash to generate a social connection hash (SC1);
generating a random number (R1) for the social connection between the first user and the second user based on a random number generation algorithm;
generating a zero-knowledge social connection hash (ZKSC1) by applying the hashing algorithm to a combination of the social connection hash (SC1) and the random number (R1), wherein the zero-knowledge social connection hash (ZKSC1) provides cryptographic proof of connection existence without enabling reverse-engineering of the underlying communication addresses;
storing, by the storage module (218), the random number (R1) and the zero-knowledge social connection hash (ZKSC1) on the server (108), wherein the random number (R1) is stored in association with the zero-knowledge social connection hash (ZKSC1); and
verifying, by a verification module (226), the social connection between the first user and the second user upon initiation of an application session, by:
regenerating a real-time social connection hash (SC2) based on the first user communication address hash and the second user communication address hash generated in real-time,
retrieving the random number (R1) from the server (108),
generating a real-time zero-knowledge social connection hash (ZKSC2) by applying the hashing algorithm to a combination of the real-time social connection hash (SC2) and the random number (R1), and
comparing the real-time zero-knowledge social connection hash (ZKSC2) with the zero-knowledge social connection hash (ZKSC1) stored on the server (108), wherein the social connection is verified when the real-time zero-knowledge social connection hash (ZKSC2) matches the zero-knowledge social connection hash (ZKSC1) stored on the server (108).

2. The system as claimed in claim 1, wherein the first user's public key, the first user's private key, the second user's public key, and the second user's private key are generated based on processing of biometric factors of the first user and the second user OR based on an asymmetric key generation algorithm, wherein the first user's private key and second user's private key is stored at the first user device and the second user device respectively.

3. The system as claimed in claim 2, wherein the biometric factors comprise one or more of face, fingerprint, iris, retina, or voice, and wherein the first user communication address and the second user communication address is selected from email addresses, phone numbers or proxy communication addresses.

4. The system as claimed in claim 1, wherein the personally identifiable information of the first user and the second user comprise a profile photo, a name, a username, and any other personally identifying information.

5. The system as claimed in claim 1 further comprises a social discovery module (228) with a connection request routing mechanism that transmits connection requests without revealing source addresses or destination addresses of the first user device or the second user device.

6. The system as claimed in claim 1, wherein the notification module (222) is configured to compare the second user communication address hash generated in real-time with the second user communication address hash stored on the server (108) and send the connection request when the second user communication address hash generated in real-time matches the second user communication address hash stored on the server (108).

7. The system as claimed in claim 1 further comprises a Performance Optimization Module (230), wherein the Performance Optimization Module (230) employs machine learning algorithms for predicting access patterns and preloading frequently accessed social connection data into cache memory, wherein the machine learning algorithms analyze temporal access patterns and social graph topology for prediction optimization.

8. A method (300) for zero-knowledge social graph management, with session-revealed identities, the method (300) comprising steps of:
receiving (302), by a user registration module (212), a first registration request, from a first user of a first user device, wherein the first registration request comprises a first user communication address;
receiving (304), by the user registration module (212), a second registration request, from a second user of a second user device, wherein the second registration request comprises a second user communication address;
generating (306), by a hash generation module (214), a first user communication address hash and a second user communication address hash by hashing the first user communication address and the second user communication address respectively;
generating (308), by a key generation module (216), a first user's public key and a first user's private key corresponding to the first user, and a second user's public key and a second user's private key corresponding to the second user;
storing (310), by a storage module (218), the first user communication address hash, the second user communication address hash, the first user's public key, and second user's public key on a server (108), thereby registering the first user and the second user;
generating (312), by a connection request module (220), an encrypted first user identity packet comprised of personally identifiable information of the first user, wherein the encrypted first user identity packet is encrypted using the second user's public key;
receiving (314), by the hash generation module (214), a communication address of the second user, wherein the communication address of the second user is entered by the first user at the first user device;
hashing (316), by the hash generation module (214), the communication address of the second user to generate a second user communication address hash;
receiving (318), by a connection request module (220), a connection request from the first user targeting the second user, wherein the connection request comprises the second user communication address hash and the encrypted first user identity packet;
sending (320), by a notification module (222), the connection request bundled with the encrypted first user identity packet, to the second user device;
decrypting (322), by a packet processing module (224), the first user identity packet with the second user's private key when the second user reviews the connection request, and revealing the personally identifiable information of the first user to the second user on the second user device;
generating (324), by the hash generation module (214), a zero-knowledge social connection hash (ZKSC1) when the second user accepts the connection request from the first user, wherein the zero-knowledge social connection hash (ZKSC1) is generated by:
applying a hashing algorithm to a combination of the first user communication address hash and the second user communication address hash to generate a social connection hash (SC1);
generating a random number (R1) for the social connection between the first user and the second user based on a random number generation algorithm;
generating a zero-knowledge social connection hash (ZKSC1) by applying the hashing algorithm to a combination of the social connection hash (SC1) and the random number (R1), wherein the zero-knowledge social connection hash (ZKSC1) provides cryptographic proof of connection existence without enabling reverse-engineering of the underlying communication addresses;
storing, by the storage module (218), the random number (R1) and the zero-knowledge social connection hash (ZKSC1) on the server (108), wherein the random number (R1) is stored in association with the zero-knowledge social connection hash (ZKSC1); and
verifying (326), by a verification module (226), the social connection between the first user and the second user upon initiation of an application session, by:
regenerating a real-time social connection hash (SC2) based on the first user communication address hash and the second user communication address hash generated in real-time,
retrieving the random number (R1) from the server (108),
generating a real-time zero-knowledge social connection hash (ZKSC2) by applying the hashing algorithm to a combination of the real-time social connection hash (SC2) and the random number (R1), and
comparing the real-time zero-knowledge social connection hash (ZKSC2) with the zero-knowledge social connection hash (ZKSC1) stored on the server (108) wherein the social connection is verified when the real-time zero-knowledge social connection hash (ZKSC2) matches the zero-knowledge social connection hash (ZKSC1) stored on the server (108).

9. The method as claimed in claim 8, wherein the first user's public key, the first user's private key, the second user's public key, and the second user's private key are generated based on processing of biometric factors of the first user and the second user OR based on an asymmetric key generation algorithm, wherein the first user's private key and second user's private key is stored at the first user device and the second user device respectively.

10. The method as claimed in claim 9, wherein the biometric factors comprise one or more of face, fingerprint, iris, retina, or voice, and wherein the first user communication address and the second user communication address is selected from email addresses, phone numbers or proxy communication addresses.

11. The method as claimed in claim 8, wherein the personally identifiable information of the first user and the second user comprise a profile photo, a name, a username, and any other personally identifying information.

12. The method as claimed in claim 8 further comprises transmitting, by a social discovery module (228) with a connection request routing mechanism, connection requests without revealing source addresses or destination addresses of the first user device or the second user device.

13. The method as claimed in claim 8, wherein the notification module (222) is configured to compare the second user communication address hash generated in real-time with the second user communication address hash stored on the server (108) and send the connection request when the second user communication address hash generated in real-time matches the second user communication address hash stored on the server (108).

14. The method as claimed in claim 8 further comprises employing, a Performance Optimization Module (230), machine learning algorithms for predicting access patterns and preloading frequently accessed social connection data into cache memory, wherein the machine learning algorithms analyze temporal access patterns and social graph topology for prediction optimization.

15. A computer program product for zero-knowledge social graph management, with session-revealed identities, the computer program product comprising a non-transitory computer-readable storage medium having program instructions embodied therewith, wherein the program instructions are executable by a processor (202) for:
receiving, by a user registration module (212), a first registration request, from a first user of a first user device, wherein the first registration request comprises a first user communication address;
receiving, by the user registration module (212), a second registration request, from a second user of a second user device, wherein the second registration request comprises a second user communication address;
generating, by a hash generation module (214), a first user communication address hash and a second user communication address hash by hashing the first user communication address and the second user communication address respectively;
generating, by a key generation module (216), a first user's public key and a first user's private key corresponding to the first user, and a second user's public key and a second user's private key corresponding to the second user;
storing, by a storage module (218), the first user communication address hash, the second user communication address hash, the first user's public key, and second user's public key on a server (108), thereby registering the first user and the second user;
generating, by a connection request module (220), an encrypted first user identity packet comprised of personally identifiable information of the first user, wherein the encrypted first user identity packet is encrypted using the second user's public key;
receiving, by the hash generation module (214), a communication address of the second user, wherein the communication address of the second user is entered by the first user at the first user device;
hashing, by the hash generation module (214), the communication address of the second user to generate a second user communication address hash;
receiving, by a connection request module (220), a connection request from the first user targeting the second user, wherein the connection request comprises the second user communication address hash and the encrypted first user identity packet;
sending, by a notification module (222), the connection request bundled with the encrypted first user identity packet, to the second user device;
decrypting, by a packet processing module (224), the first user identity packet with the second user's private key when the second user reviews the connection request, and revealing the personally identifiable information of the first user to the second user on the second user device;
generating, by the hash generation module (214), a zero-knowledge social connection hash (ZKSC1) when the second user accepts the connection request from the first user, wherein the zero-knowledge social connection hash (ZKSC1) is generated by:
applying a hashing algorithm to a combination of the first user communication address hash and the second user communication address hash to generate a social connection hash (SC1);
generating a random number (R1) for the social connection between the first user and the second user based on a random number generation algorithm;
generating a zero-knowledge social connection hash (ZKSC1) by applying the hashing algorithm to a combination of the social connection hash (SC1) and the random number (R1), wherein the zero-knowledge social connection hash (ZKSC1) provides cryptographic proof of connection existence without enabling reverse-engineering of the underlying communication addresses;
storing, by the storage module (218), the random number (R1) and the zero-knowledge social connection hash (ZKSC1) on the server (108), wherein the random number (R1) is stored in association with the zero-knowledge social connection hash (ZKSC1); and
verifying, by a verification module (226), the social connection between the first user and the second user upon initiation of an application session, by:
regenerating a real-time social connection hash (SC2) based on the first user communication address hash and the second user communication address hash generated in real-time,
retrieving the random number (R1) from the server (108),
generating a real-time zero-knowledge social connection hash (ZKSC2) by applying the hashing algorithm to a combination of the real-time social connection hash (SC2) and the random number (R1), and
comparing the real-time zero-knowledge social connection hash (ZKSC2) with the zero-knowledge social connection hash (ZKSC1) stored on the server (108) wherein the social connection is verified when the real-time zero-knowledge social connection hash (ZKSC2) matches the zero-knowledge social connection hash (ZKSC1) stored on the server (108).
